(19) United States
(12) Patent Application Publication
(10) Pub. No.: US 2002/0035486 A1
(43) Pub. Date: Mar. 21, 2002

(54) Computerized clinical questionnaire with dynamically presented questions

(76) Inventors: Nam Q. Huyn, Milpitas, CA (US); Kenneth L. Melmon, Woodside, CA (US); Andrea Perrone, Mountain View, CA (US)

Correspondence Address: SWANSON & BRATSCHUN L.L.C., 1745 SHEA CENTER DRIVE, SUITE 330, HIGHLANDS RANCH, CO, 80129, US

(21) Appl. No.: 09/910,463

(22) Filed: Jul. 20, 2001

Related U.S. Application Data
(60) Provisional application No. 60/220,135, filed on Jul. 21, 2000.
(60) Provisional application No. 60/226,204, filed on Aug. 18, 2000.

(51) Int. Cl. G06F 17/60

(52) U.S. Cl. 705/3

(57) ABSTRACT

A clinical questionnaire system and method presents medical questions to a subject and determines additional questions to present based on the subject's response to previous questions. Positive responses to primary questions trigger presentation of secondary and lower-level questions requesting more specific information from the subject. Deeper-level questions follow a medical pathway correlated with a known medical condition and can prompt presentation of clinical warnings. Because the questionnaire is patient-centered, it is free from the medical bias inherent in a physician's administration of a questionnaire and orientation as to what constitutes true disease. By only presenting relevant questions, the questionnaire decreases the time burden on the subject. Longitudinal clinical data collected can be used for patient-oriented data analysis or, in combination with bioanalytical data, for biological marker discovery.

### CROSS-REFERENCE TO RELATED APPLICATIONS

This application claims the benefit of U.S. Provisional Application Nos. 60/220,135, “Computerized Medical Questionnaire and Biomarker Identification System Including Network Access,” filed Jul. 21, 2000, and 60/226,204, “Longitudinal Patient-Centered Collection and Analysis of Clinical Data,” filed Aug. 18, 2000, both of which are herein incorporated by reference. This application is related to copending U.S. application Ser. No. 09/558,909, “Phenotype and Biological Marker Identification System,” filed Apr. 26, 2000, which is herein incorporated by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present invention relates generally to medical questionnaires, and more particularly to a computer-assisted clinical questionnaire system for efficiently collecting patient responses and storing the information in a database to be accessed for clinical and research purposes.

### BACKGROUND OF THE INVENTION

A number of computer-assisted clinical questionnaire systems have been developed, primarily for providing potential patient diagnoses or tracking the treatment and progression of a previously diagnosed condition. Many of these systems are designed for use by medical practitioners rather than by patients themselves. As a result, they tend to rely upon some measure of medical knowledge and training. For example, a medical practitioner can skip questions that are presumed irrelevant to the patient's condition without biasing the results of the questionnaire; for a patient trying to complete the questionnaire, however, answering irrelevant questions creates a significant time burden. Indeed, the presence of irrelevant questions may affect the results of the questionnaire, either because the patient does not complete the questionnaire or because answering the irrelevant questions impairs the patient's ability to respond objectively to the relevant questions. Additionally, systems designed for use by medical practitioners commonly use medical terminology that would be confusing to the patient or require information that is not readily available to the patient, such as laboratory results.

DXplain and Illiad are two computer-assisted software systems designed for use by medical practitioners. DXplain was developed at Massachusetts General Hospital as a diagnostic decision-support program for medical students and physicians. The medical practitioner provides clinical information about the patient (e.g., physical signs, symptoms, and laboratory data). Based on this information, DXplain provides a ranked list of diagnoses that are classically associated with or might explain the set of clinical findings. Similarly, Illiad is designed to assist physicians in diagnosing disease and managing patients. Based on clinical information submitted by the medical practitioner, Illiad provides a differential diagnosis of the patient's condition and can also suggest treatment protocols. Neither DXplain nor Illiad is intended to follow patients longitudinally or retain the patient information in a database for further study. Rather, the systems are designed to provide the medical practitioner with information useful to solve the immediate problem presented by the patient. In addition, these tools do not allow any input directly from the patient.

Also known in the art are computerized medical diagnostic questionnaires, such as that described in U.S. Pat. No. 6,022,315, issued to Iliff. The system described in Iliff is intended to provide diagnostic and treatment advice to the general public over a computer network, such as the Internet. The Iliff system presents a number of medical complaint algorithms that pose questions to the patient and diagnoses a medical condition based upon whether the patient's responses result in a score exceeding a threshold value. The questionnaire described in Iliff is not intended to illicit questions about the general state of a patient's health, but rather to arrive at a diagnosis. One limitation of the system is that once the algorithm is keyed toward a particular disease, the questions do not elicit responses regarding a patient's condition or state of health that are inconsistent or not immediately relevant to the hypothesis, unless that hypothesis is subsequently ruled out. As a result, the responses collected by the system described in Iliff provide an incomplete view of the patient's overall medical status or well-being.

U.S. Pat. No. 5,572,421, issued to Altman et al., is directed to a handheld, battery powered device for administering a medical questionnaire to a patient. The device is controlled by a pre-programmed microcomputer that stores into memory the text of user instructions and medical or health related questions. The microcomputer is programmed to tally the patient's answers and, based on that information and any objective data that might be supplied by a medical practitioner, to present an evaluation of the patient's medical condition or status. That evaluation may include recommendations for tests, an assessment of the patient's general medical condition, an analysis of the patient's functional health status, or any conclusions inferred from the patient's responses. Like the system described in Iliff, the device described in Altman seeks to reach a conclusion or recommendation based upon the patient's response. The device described in Altman excludes certain questions based on the sex of the patient and provides follow-up questions to allow elaboration of answers to specific question. However, these follow-up questions are provided with a blank line to be filled in on a printout of the questions and answers. Thus, Altman teaches only a rudimentary level of follow-up to a line of questioning that cannot be answered within the automated environment of the handheld device.

An interactive system for managing physical exams, diagnoses, and treatment protocols is disclosed in U.S. Pat. No. 6,047,259, issued to Campbell et al. The computerized system guides a health-care professional through a medical exam, prompting the user for additional information and observations when necessary. Context-sensitive questions are generated dynamically based on prior input within the current or previous sessions. After all observations are recorded, the system generates a list of possible diagnoses with associated treatment protocols. The user can select a diagnosis and treatment, and future exams reflect the selected protocol by requesting information about its required services. One drawback of the system of Campbell is that both the questions (or observation requests) and conditions for triggering additional questions are preprogrammed. While hard-coding the exam content is efficient for performing a known exam using well-established protocols and diagnostic algorithms, it does not provide flexibility for changing the selected questions, question types, or conditional relationships among questions and observations. Changes to the exam content would require rewriting of the program code. The system of Campbell et al. is therefore not well suited for an experimental or research environment.

U.S. Pat. No. 6,108,665, issued to Bair et al., discloses a system and method for collecting behavioral health data. One aspect of the system is a questionnaire operated by a therapist for collecting general or condition-specific information from a patient. The therapist can select an existing questionnaire or create a questionnaire from a database of existing questions or newly created questions. When creating a questionnaire, the therapist selects among potential question entry patterns such as branched entry, in which an answer to one question determines whether the next question in the sequence is asked. For example, if the patient has no history of alcohol abuse, the alcohol-related questions are skipped. The questionnaire is administered by the therapist, not the patient, and so the questionnaire type and questions within the questionnaire are tailored to the therapist's previous knowledge of the patient. As with many other prior art systems, the questionnaire is not directed toward general health and well-being, and the level of question branching is quite rudimentary.

A number of short, health-related questionnaires, some of them web-based, have been used in general population surveys, clinical practice, and medical research. For example, the SF-36⁰ Health Survey is a health risk assessment questionnaire consisting of 36 multiple choice questions. Although the SF-36⁰ Health Survey can be completed by the patient, it is not designed to gather comprehensive organ system information, and is fixed to 36 questions. Forms are also available on the web for completion by prospective participants in clinical trials. A user enters basic medical information into a form, the information is stored, and the user is contacted if an applicable clinical trial becomes available for participation. Simple medical surveys are also available as web-based forms. In general, such web-based surveys consist of single-or multi-page forms that are static: the user completes a set number of questions and clicks a submit button to submit the data to the web server. There is no substantial interactive behavior between the user and questionnaire.

Systems have recently been developed to acquire clinical data for research and analysis purposes. For example, U.S. Pat. No. 6,196,970, issued to Brown, discloses a system for collecting data from research subjects in a clinical trial and relaying the data to a central site for aggregation and analysis. The questionnaire employed provides standard possible responses to the subjects to prevent them from entering “fuzzy” self-assessments. The system processor analyzes the received data in real time, allowing for adjustment of the study protocol before all the data are collected, for example, if dangerous side effects of an experimental drug are noted. Question content can be varied in response to a subject's previous answer, but triggered questions are intended primarily to restrict and standardize the subject's response, not to gain more information about the subject. Thus questions are not tailored to particular subjects in order to obtain a complete medical description of the subject, but rather to ensure that the same information is obtained from each subject. The questions are also restricted to the particular protocol being investigated and do not elicit general medical information from the subject.

None of the existing computer-assisted medical questionnaires, therefore, provides a suitable system for acquiring broad, unbiased, and longitudinal data from patients for use in both clinical and research applications. There is still a need for a patient-centered questionnaire system that dynamically selects questions for presentation, allows flexibility in questionnaire design, obtains comprehensive information, and incorporates existing medical wisdom.

### SUMMARY OF THE INVENTION

The present invention provides a computer-implemented questionnaire system and method for obtaining clinical data from subjects. Unlike conventional computer-assisted questionnaires, in which a fixed set of questions are displayed in the same order, questions of the present invention are dynamically linked in dependence on previous responses received from the subject. The questions are organized into sets or forms containing logically related questions, and both the content of an individual form and the specific forms presented change as the subject provides responses. Questions are structured into hierarchical levels that reflect symptom severity or specificity; thus as the subject responds positively to general symptomatic questions, more detailed questions are presented that follow a medical pathway leading to a potential medical condition. However, a broad range of questions is generally presented to all users, regardless of responses.

In particular, the present invention provides a computer-implemented method for obtaining clinical data, containing the following steps: obtaining medical questions and question linking conditions from a database, presenting at least one of the medical questions to a user, receiving response data from the user, and displaying additional questions to the user, depending upon the response data and question linking conditions. Preferably, each question has an associated linking condition (containing one or more expressions), and all conditions are evaluated each time new response data are received. For each condition that evaluates to true, its associated question is presented to the user. Preferably, questions are organized into forms of related questions, and forms are presented when associated form linking conditions, evaluated based on response data, are true. Similarly, question assembly conditions determine which questions are included in a particular form. Responses are preferably weighted, and the evaluation conditions (form assembly, question assembly, or question linking) depend on the response weights. In addition, response data can be examined for consistency, and the user alerted to inconsistent results. Questions can be presented to the user by textual, graphic, auditory, or any other means, and response data can be received directly from a medical instrument. After all data have been received, a summary analysis can be presented to the user or to a physician, e.g., via different access codes.

Questions are preferably organized into higher-level questions and lower-level questions. Positive responses to higher-level questions trigger presentation of lower-level questions. Typically, combinations of higher- and lower-level question responses represent medical pathways associated with predetermined medical conditions. Preferably, clinical alert conditions corresponding to the medical pathways are obtained from the database and compared with response data. If the comparison indicates that the user's symptoms correspond to the medical pathway, a clinical alert is presented to the user or to a designated person such as a physician. Alternatively, the designated person is contacted by, for example, email or pager. The user can also be presented with a set of disease-specific questions corresponding to the identified medical pathway.

The method is preferably implemented in a distributed computer system containing a client machine, which presents the questions to the user and receives response data, and a server machine that accesses the database. Questions, conditions, and response data are transmitted between the client and server. Conditions can be evaluated by the server, the client, or both the server and client. Intermediate response data are temporarily stored in the client machine, while committed response data are stored in a database, which preferably also contains response data from other users, response data received from the user at a different time, and laboratory data for a large number of users.

The present invention also provides a clinical questionnaire system consisting of a database that stores questionnaire objects, including clinical questions, question presentation conditions, forms, and form linking conditions; a web server in communication with the database; and a web browser in communication with the web server. The web browser presents selected clinical questions to a user and receives response data. Clinical questions are selected for presentation in dependence on the question presentation conditions and on the received response data.

Also provided is a program storage device accessible by a processor and tangibly embodying a program of instructions executable by the computer to perform method steps for the above-described methods.

### BRIEF DESCRIPTION OF THE FIGURES

FIG. 1 is a block diagram of a preferred software architecture for implementing the present invention.

FIG. 2 is a block diagram of a computer system for implementing the software architecture of FIG. 1.

FIGS. 3-5 are alternative embodiments of computer systems for implementing the software architecture of FIG. 1.

FIG. 6 is a schematic diagram of a questionnaire according to the present invention.

FIG. 7 is an entity-relationship diagram of the object model used in the questionnaire of FIG. 6.

FIG. 8A is a flow diagram illustrating the form linking logic of the present invention.

FIG. 8B is a flow diagram illustrating the question assembly logic and question linking logic of the present invention.

FIGS. 9A-9C are flow diagrams of a questionnaire method of the invention.

FIGS. 10A-10C show the Chief Complaint form of a General Clinical questionnaire of the invention.

FIGS. 11A-11H show the Head and Neck form of the General Clinical questionnaire.

FIG. 12 shows the Family History form of the General Clinical questionnaire.

FIG. 13 shows a graphical form for receiving subject response data.

FIG. 14 shows a graphical summary analysis display describing patient response data collected from a single questionnaire session.

FIG. 15 shows a tabular summary analysis display describing patient response data collected from a single questionnaire session.

FIG. 16 shows a clinical warning screen triggered by patient response data corresponding to a medical pathway.

FIG. 17 is a block diagram of a biomarker discovery system incorporating the questionnaire system of the present invention.

FIG. 18 is a flow diagram of a biomarker discovery method using a database of data collected according to the present invention.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

The present invention provides a computer-assisted medical questionnaire for obtaining broad, longitudinal clinical data directly from subjects, also referred to as patients or users. The presented questions are selected dynamically as the subject responds to questions, and the conditions determining which questions are selected can themselves be updated without having to change the questionnaire software significantly. In contrast to standard computer-assisted questionnaires, which are rigid and preset, a questionnaire according to the present invention unfolds dynamically as the user responds to questions. Collected data are stored in a database that is structured to allow for subsequent data analysis and mining.

An important, outcome of the patient-centered approach of the present invention is that there is no inherent bias in selecting questions to present to the subject. For example, if a patient presents a physician with a specific medical complaint, the physician typically considers possible diagnoses and selects subsequent questions in order to narrow the list of potential diagnoses. Thus the subsequent questions are constrained by existing medical knowledge: it is unlikely that clinical pathways that have not yet been elucidated can be discovered. Furthermore, diagnoses are made based on classical symptoms, which tend to occur at a late stage in disease progression. Thus, by the time a physician recognizes a disease symptom, the disease has often progressed beyond the point at which it can be cured. Additionally, when a patient has multiple diseases, it is difficult for the physician to identify the multiple diseases based on the patient's multiple and often related symptoms. Conventional diagnostic software systems are modeled on the same principles and gather information directed toward diagnosing the condition motivating the patient visit, based on the classical symptoms presented.

The questionnaire of the present invention has a completely different purpose; not primarily a diagnostic tool, it is intended for broad information gathering from a large number of subjects. Even if a subject has a specific medical complaint and responds to the questionnaire accordingly, subsequent questions are not directed only toward obvious potential diagnoses. Instead, a broad range of questions are presented, regardless of the subject's dominant symptoms or concerns. Detailed information is gathered about the subject's symptoms, even if those symptoms are not correlated with a known or suspected condition of the subject. By gathering a large amount of data for storage in a database and subsequent data mining, the invention allows for new correlations to be made, potentially providing for disease mechanism elucidation and earlier disease diagnosis. It also allows for identification of subtle patterns of symptoms that are currently unrecognized. Early detection can provide enormous benefits, because many degenerative conditions are believed to progress in distinct stages. Currently, by the time a disease is diagnosed, it has progressed to a stage at which a cure is no longer possible. If the disease is instead diagnosed at an earlier stage using symptoms identified by the present invention, it has a much higher probability of cure.

Rather than ignore existing medical wisdom, however, the questions of the questionnaire of the present invention unfold hierarchically along known medical pathways, soliciting increasingly specific information as the subject responds positively. As a consequence, the further a single pathway unfolds, the higher the probability that the subject has an associated disease or syndrome.

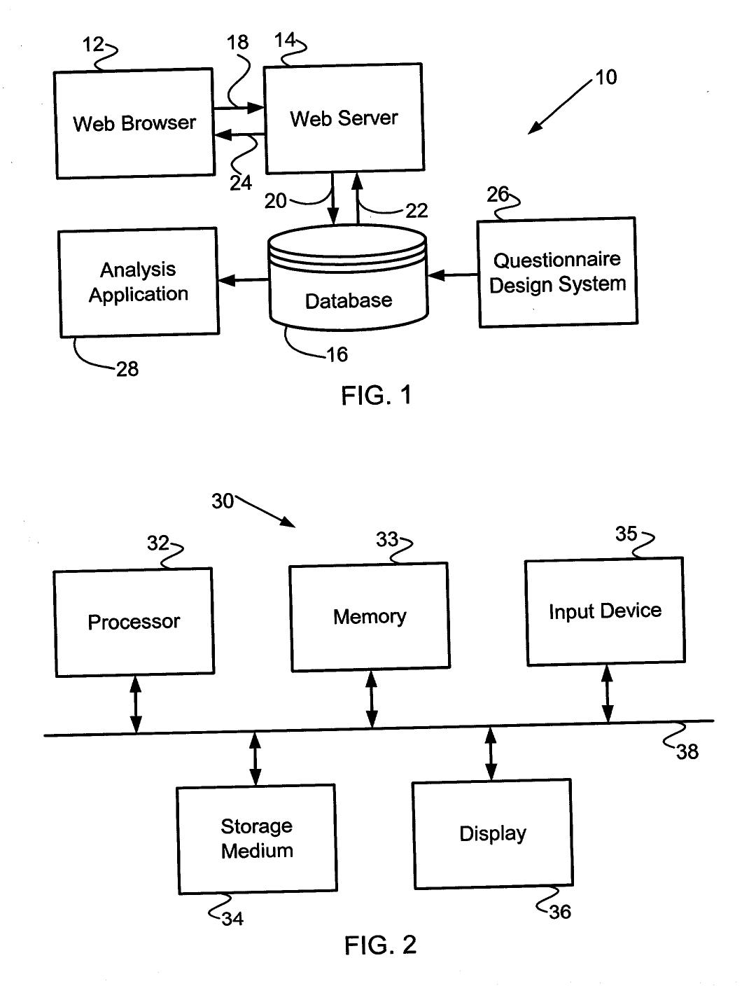

The invention is typically implemented in a distributed computer system using a three-tiered software architecture 10, illustrated schematically in FIG. 1. A web browser 12 at a client computer presents questions to a subject, receives input from the subject via one or more potential input devices, and updates the display in response to user input. The subject's input, referred to herein as response data, is transmitted from the web browser 12 to a web server 14, as indicated by an arrow 18. The committed response data (i.e., finalized versions) are transferred to (arrow 20) and stored in a database 16. The web server 14 also obtains questions and conditional logic from the database 16 (arrow 22), evaluates conditions based on response data, determines which questions to present to the user, and transmits the selected questions to the web browser 12, indicated by an arrow 24. The database 16 can be considered to have two distinct parts, one containing the questions and conditional logic and the other containing the response data. The database 16 is typically, but not necessarily, a relational database. To facilitate questionnaire design, a questionnaire design system 26 is in communication with the database 16. A clinician designing a particular questionnaire uses the design system 26 to input questions and conditional links among questions, and the information is stored in the database 16. In this way, the clinician does not need to know database programming or the underlying structure of the system in order to create questionnaires.

The software modules can use commercially-available software or software created specifically for the present invention. For example, the web browser 12 is preferably a conventional web browser that supports dynamic hypertext markup language (DHTML) standards, such as Microsoft Internet Explorer (version 5.0 or higher) or Netscape Navigator (version 6.0 or higher). The web server 14 preferably supports a standard scripting language such as ECMAScript. The database 16 can be, for example, Microsoft ACCESS® (for PC applications) or ORACLE® (for mainframe applications).

As shown in FIG. 1, one or more additional data analysis applications 28 are in communication with the database 16 for performing any desired analysis of the collected data. For example, a particularly useful application 28 is a data mining application. As described in greater detail below, a data mining application can be used to search for and identify symptoms, physical signs, laboratory data, or other markers of disease. Once such common markers are identified, the data mining application can then search the historical responses of other patients for those same markers, either to anticipate the occurrence of the disease in those patients or to validate the symptom's status as a marker.

The software architecture 10 can be implemented in any suitable hardware configuration, depending upon the environment in which the questionnaire is administered and the available equipment. In the simplest embodiment, an entire questionnaire is implemented on a single computer 30, illustrated schematically in FIG. 2. The computer 30 can be a mainframe computer, desktop computer, workstation, laptop computer, Personal Digital Assistant, or any other similar device having sufficient memory, processing capabilities, and input and output capabilities to implement the invention. The device can be a dedicated device used specifically for implementing the invention or a commercially available device programmed to implement the invention. The computer 30 contains a processor 32, a memory 33, a storage medium 34, an input device 35, and a display 36, all communicating over a data bus 38. Although only one of each component is illustrated, any number of each component can be included. For example, the computer 30 typically contains a number of different data storage media 34.

The processor 32 executes methods of the invention under the direction of computer program code stored within the computer 30. Using techniques well known in the computer arts, such code is tangibly embodied within a computer program storage device accessible by the processor 32, e.g., within system memory 33 or on a computer readable storage medium 34 such as a hard disk or CD-ROM. The methods can be implemented by any means known in the art. For example, any number of computer programming languages, such as Java, C++, or LISP can be used. Furthermore, various programming approaches such as procedural or object oriented can be employed. The database is stored in the storage medium 34 or memory 33 and queried by a database server using conventional methods and communication protocols.

The display 36 presents questions to the subject, and response data are received via the input device 35. Although the display 36 is typically a monitor and the input device 35 typically a keyboard and/or mouse, devices tailored to input or present particular data types can also be used. Input device examples include touch screens, anatomical models, and medical instruments for noninvasive physical testing, such as a blood pressure cuff, pulse oximeter, thermometer, or inspirometer. The display 36 can present the questions and related information by visual, auditory, or tactile means, or any combination of these formats.

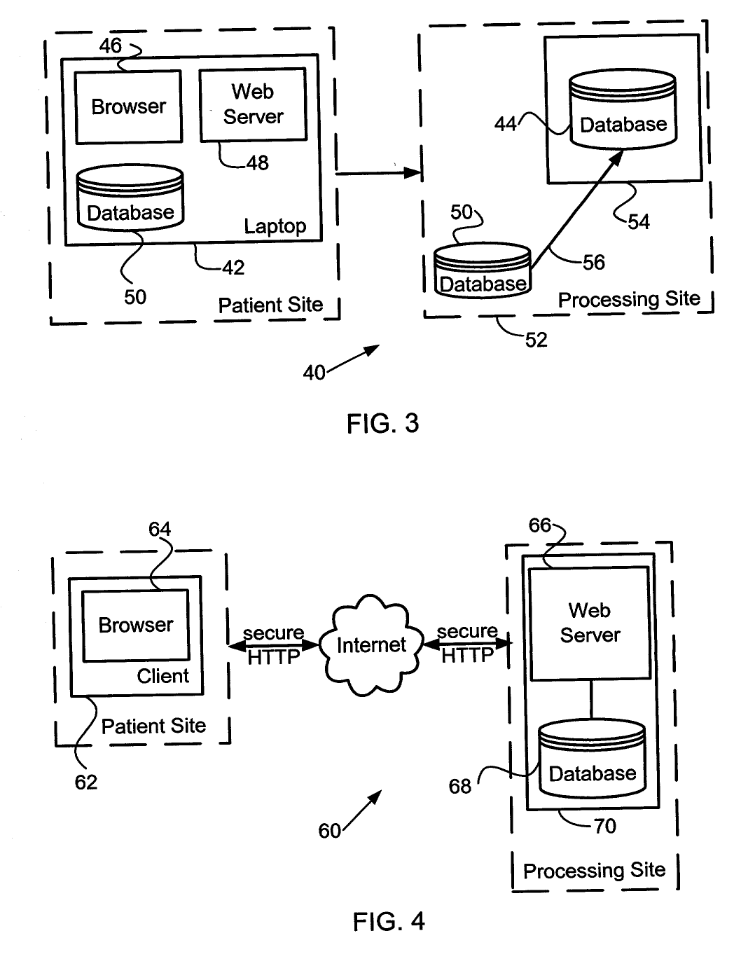

Preferably, the invention is instead implemented in a distributed or networked computer system in which the different software modules are executed by different computers in order to maximize the efficiency of the questionnaire method. FIG. 3 schematically illustrates an embodiment 40 in which the entire questionnaire is performed using a single computer 42, followed by uploading of the response data to a more functionally robust database 44 for permanent storage and processing. In this embodiment, the computer 42 is a portable computer (e.g., laptop computer) that includes a web browser 46, personal web server 48, and personal database server 50. The computer 42 is brought to the location of a subject for collection of subject responses to the questionnaire and then returned to a processing location 52, the site of a mainframe computer 54 containing the database 44. The response data maintained on the personal database 50 of the portable computer 42 are uploaded to the database server 44 of the mainframe computer as indicated by arrow 56.

FIG. 4 illustrates an alternative embodiment 60 of the hardware configuration, in which questions and response data are transmitted over the Internet. A client computer 62 at the subject's location contains a web browser 64 and communicates with a web server 66 using a secure transfer protocol such as HTTPS (secure hypertext transfer protocol). The web server 66 accesses a database 68 for storing permanent response data and obtaining questions and conditional logic. The web server 66 and database 68 can be hosted on a single mainframe computer 70 as illustrated, or on two or more computers in communication with each other. The client computer 62 can be a workstation, laptop, handheld device, or any other device capable of accessing the Internet through conventional wired or wireless means. Note that the client computer 62 can alternatively connect directly to the web server 66 using a standard modem and direct telephone line connection.

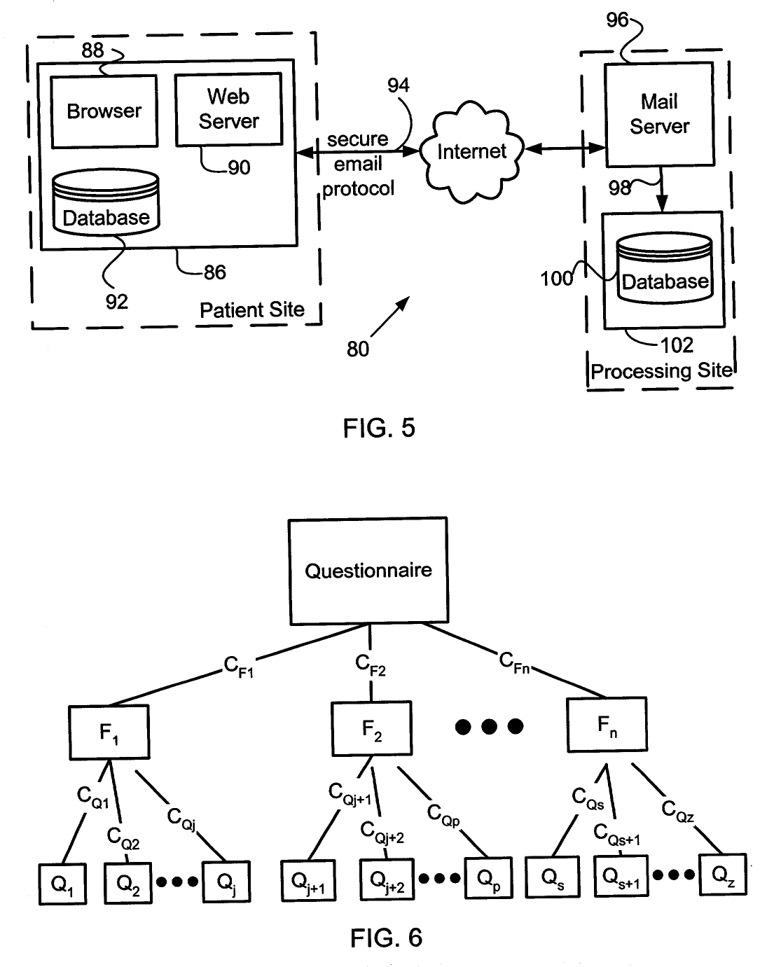

An additional hardware embodiment 80 is shown schematically in FIG. 5. This embodiment 80 is similar to that of FIG. 3, except that rather than being physically transported in a computer from the patient site to the processing site, the data collected at the patient site are transmitted via email to the processing site. Again, a computer 86, such as a workstation or laptop computer, hosts a web browser 88, a web server 90, and a database 92. A user initiates a connection to the Internet in any known manner, and subject responses are conveyed to the processing location via the Internet by means of a secured email protocol 94. At the processing location, the response data are received by a conventional mail server 96 and extracted and uploaded, as indicated by arrow 98, to a database 100 residing on a mainframe computer 102.

It will be apparent to one skilled in the art that many other potential implementations of the software architecture 10 can be employed; the above embodiments are merely illustrative and in no way limit the scope of the invention. Any possible distribution of the method steps and software modules among different computers using any possible communication and transmission among the computers is within the scope of the present invention. Furthermore, although the figures illustrate the questions and response data as being stored in a single database, any number of databases, relational or otherwise, can be used.

A schematic diagram of the conceptual structure of a questionnaire according to the present invention is shown in FIG. 6. As implemented in the present invention, a questionnaire preferably consists of a number of forms F₁ through Fₙ, each containing a set of related potential questions Qᵢ. For example, each form can focus on a particular organ system (e.g., pulmonary system or thyroid) or type of potential question (e.g., health insurance information or family history). Although the forms are shown as numbered for identification purposes, they can be presented in any order, and not all forms must be presented to each subject. In addition, each potential question can be associated with one or more response items (not shown) from which a user selects. Alternatively, a user can enter free text in response to a question.

In general, not all potential questions of a given form are presented to a subject; rather, the presented questions are selected dynamically based on the subject's response to previous questions, either on the same or on different forms. The set of presented questions can change as the subject responds to questions, and thus a given subject may or may not see a particular form change in response to his or her answers or other data received. As shown in FIG. 6, the links between a form Fᵢ and its questions Qᵢ, and also to other forms, are not fixed, but are governed by conditional statements C_{Qi} and C_{Fi} containing references to particular questions and their responses. Conditional statements contain one or more Boolean expressions that can be evaluated as true or false, and a question or form is presented only if its associated condition evaluates to true. For example, a typical conditional statement is “if the subject responded positively to the question ‘have you lost weight in the last six months?’, present the question ‘how much weight have you lost?’.” Of course, much more complex expressions that depend upon responses to more than one question can be used. In certain instances, the conditions can always evaluate to true or always evaluate to false.

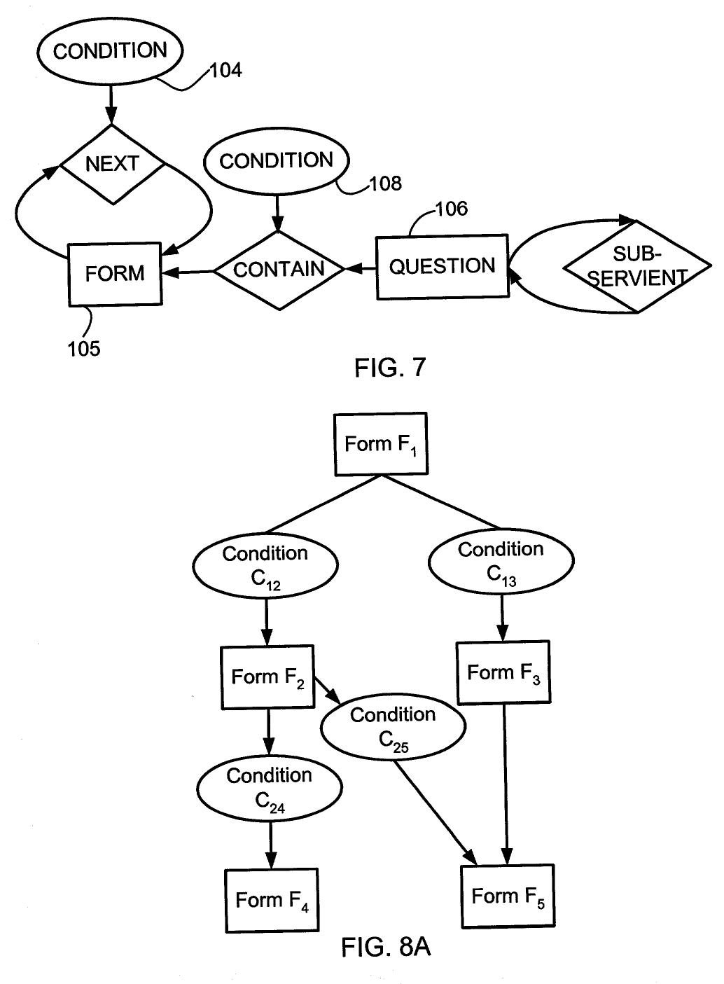

Questions, forms, conditions, and response items are represented as database objects. Object models are shown schematically in the entity-relationship diagram of FIG. 7, in which objects are represented as rectangles, relationships among objects as diamonds, and attributes as ovals. Questions and responses are stored as strings identified by question identifiers and response identifiers, respectively. They can alternatively be represented by specific data types. Conditions are any Boolean combination of atomic expressions of a user response to questions (e.g., Q376=“Yes”). The conditions shown represent two different types of logic that are evaluated at run time. At the highest level is form linking logic, which determines which form to present next, i.e., the next set of potential questions. For example, the evaluation of condition 104 determines whether form 105 will be presented next. Question linking logic determines which of the potential questions in a given form will be presented to the subject. For each question 106 in a form, a condition 108 is evaluated, and all questions whose conditions evaluate to true are presented. An additional optional relationship among questions is subservience, which is used to define the hierarchical level of questions (discussed further below). Representing questions and conditions as database objects provides increased flexibility and scalability of the system. Using the questionnaire design system 26 (FIG. 1), a clinical researcher can edit these database objects without programming the system directly. Furthermore, this structure of the questionnaire system provides for integration with existing electronic medical record or other software systems.

In a preferred embodiment of the invention, an additional level of conditional logic is employed intermediate between question linking and form linking logics. The additional level is included simply for optimization purposes, as explained further below, and is conceptually equivalent to question linking logic. Question assembly logic determines which potential questions to assemble into a form; assembled questions are referred to as included questions. Potential questions that are not assembled into a form will not be presented. However, not all included questions are presented, but only as determined by the question linking logic. A common example of question assembly logic evaluates the response to the question, “Are you currently taking any medication?” Forms can contain medication-specific questions (e.g., “Are you currently taking a corticosteroid for your arthritis?”), and if the user previously responded that he or she is not taking any medication, the medication-specific questions are not assembled into subsequent forms. The key difference between question assembly logic and question linking logic is that the question assembly conditions depend on responses provided in forms other than the current one, while the question linking conditions may depend on responses provided in the current form. From the system point of view, however, there is no functional difference between the question linking and question assembly conditions.

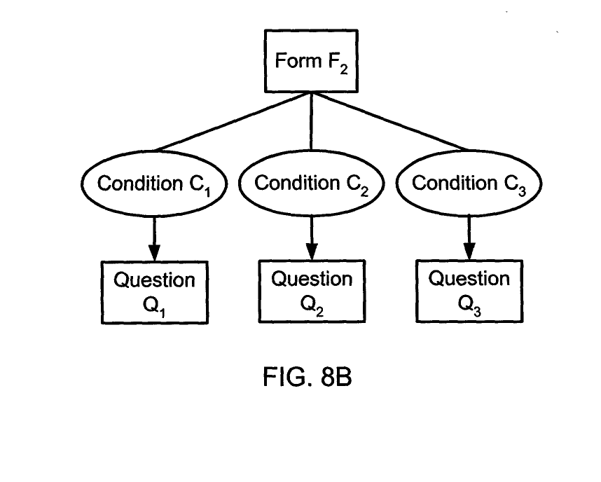

FIGS. 8A-8B are flow diagrams schematically illustrating the three different types of logic for selecting forms and questions. Form linking logic is illustrated in FIG. 8A, which shows a branched conditional structure for presenting five different forms. After the subject completes and submits form F₁, the root form, the system evaluates conditions C₁₂ and C₁₃ based on responses to specific questions in form F₁. If condition C₁₂ evaluates to true, then form F₂ is presented to the subject next. Otherwise, if condition C₁₃ evaluates to true, then form F₃ is presented to the subject. If neither condition is true, then no additional forms are presented and the questionnaire can be completed. If condition C₂₅ is satisfied in form F₂, or if form F₃ has been presented, then form F₅ is next presented. If condition C₂₄ is satisfied in form F₂, then form F₄ is presented.

Typically, a single form can lead to multiple forms; e.g., both conditions C₁₂ and C₁₃ can evaluate to true. Various mechanisms can be employed to determine which form should be presented next in such a situation. For example, the conditions and associated forms can be ordered; e.g., condition C₁₂ is always evaluated before condition C₁₃. If, in this case, it is desired to present both forms C₂ and C₃, then a condition C₂₃ having the same content as condition C₁₃ should also be associated with form C₃. The linkages between forms then appear more as a network than as a linear flow. Any desired pathway among forms can be implemented using this structure.

FIG. 8B is a flow diagram illustrating the question assembly logic and question linking logic. In determining the content of form F₂ before its initial presentation, the system determines whether previously received responses satisfy conditions that trigger inclusion of particular potential questions in the form. Thus, as illustrated in FIG. 8B, if condition C₁ is satisfied, question Q₁ is included in form F₂. Likewise, if condition C₂ or C₃ is satisfied, question Q₂ or Q₃ is included, respectively. In the case of question assembly logic, the three conditions refer to questions and responses in previous forms. For question linking logic, the conditions refer to questions and responses in the current form, and the system re-evaluates the three conditions as response data are received for the current form.

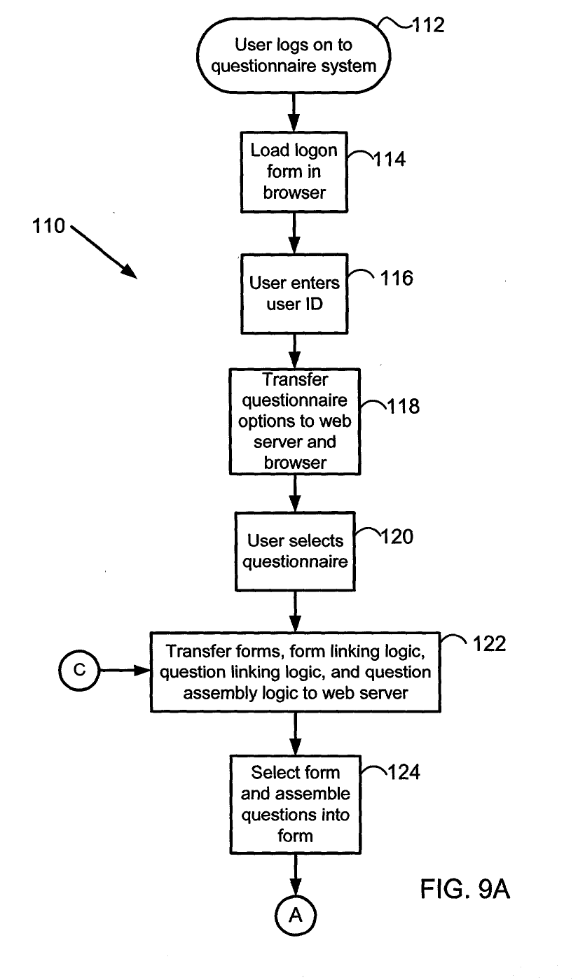

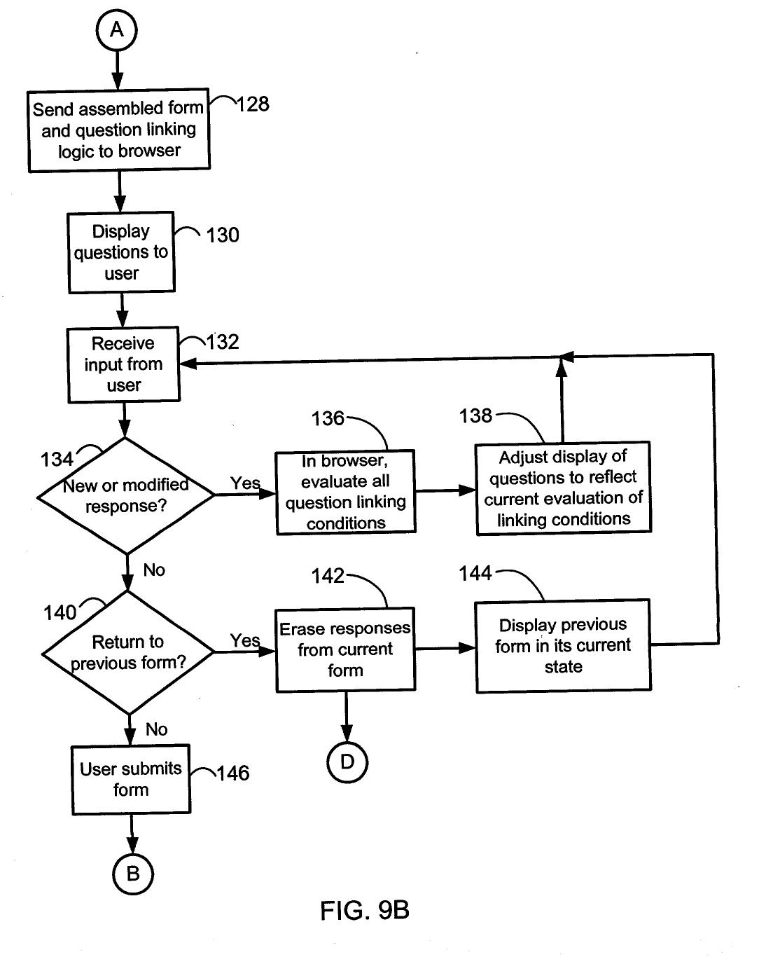

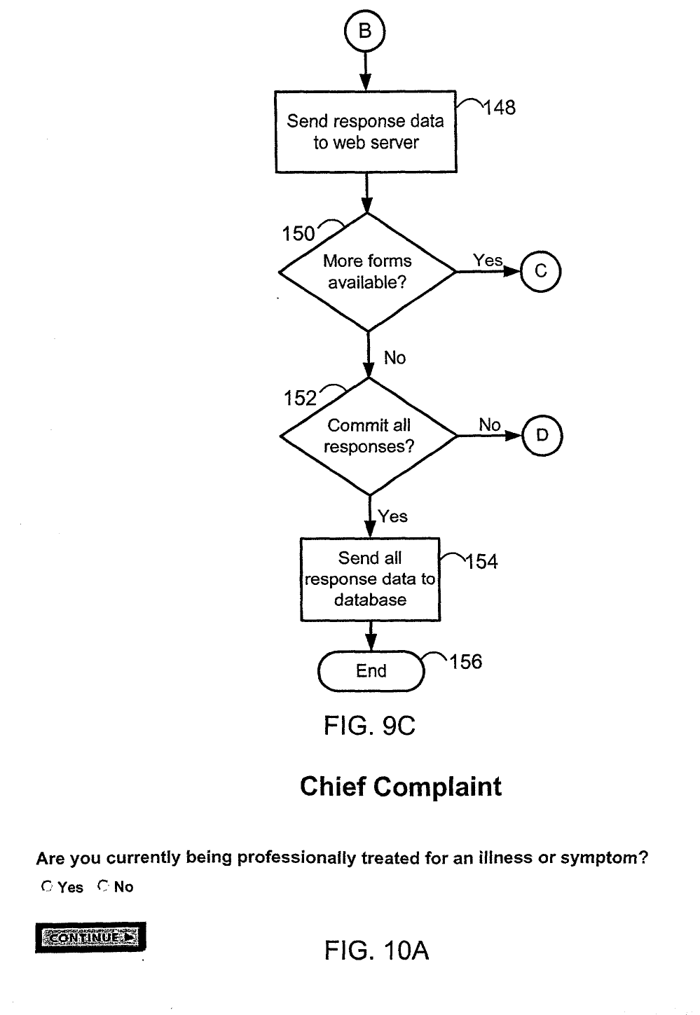

FIGS. 9A-9C are flow diagrams of a questionnaire method 110 of the invention, illustrating a preferred implementation of the software architecture 10 of FIG. 1. Beginning at state 112, a user logs on to the computerized medical questionnaire process through the web browser on the client computer. At state 114, the web browser signals the web server to load the logon form. Next, at state 116, the user enters a user ID and completes the logon form at the web browser. If the user is authenticated, at state 118, the questionnaire options available to the specified user ID are provided to the web server from the database server and then transferred via the web server to the web browser. The user then selects the desired questionnaire (state 120), and at state 122, all eligible forms with associated form linking logic, question linking logic, and question assembly logic are sent from the database to the web server. Initially, only the root form and its question assembly and question linking logic are sent to the web server. On subsequent iterations, the database sends all forms that may be presented after the most recently presented form, as determined by the form linking logic.

Moving to state 124, the web server selects the next form for presentation. If only the root form has been downloaded, then the web server automatically presents the root form. On subsequent iterations, the form is selected by evaluating one or more form linking conditions and selecting the form whose condition evaluates to true. The web server then dynamically assembles the questions by evaluating the question assembly condition for each potential question in the form. Continuing with FIG. 9B, at state 128, the assembled form, question linking condition for each included question, and any additional logical dependencies are downloaded to the web browser. The web browser evaluates all question linking conditions and displays the resulting questions to the user at state 130.

At state 132 the subject inputs one of three options: (1) abandon the current form and return to a previous form; (2) specify a new response or modify an existing response to a question on the current form; or (3) indicate that the current form has been completed. At decision state 134, the web browser determines whether the user specified a new response or modified an existing response to a question on the current form. If so, at state 136, the web browser reevaluates the question linking logic for all questions most recently transmitted from the web server (i.e., for the current form) and, at state 138, adjusts the presentation to reflect the new response data. The process then returns to state 132 to await further user input. Preferably, the browser maintains all user responses to all forms in the current session in a stack. Transitions between forms are denoted in the stack so that the stack pointer can be moved directly to the beginning of a previous form if necessary.

Note that the three-level logical hierarchy, the preferred embodiment, is an optimization that minimizes both data transmission between server and browser and data processing by the browser. If only two levels of logical dependencies are used, form and question linking logic, then all of a form's potential questions must be transmitted from the web server to the web browser. Each time the user enters a response, the browser reevaluates the conditions for each question, even if the conditions depend on responses received to questions in previous forms. By including question assembly logic, all conditions that will not change during completion of the current form are evaluated only once, as the form is being assembled. These questions and their associated conditions are not sent to the browser and therefore not evaluated by the browser.

At decision state 140, the web browser determines whether the user has elected to abandon the current form and return to the previous form (e.g., by selecting the browser's Back button). If so, at state 142, the web browser erases all responses collected in the current form and, at state 144, displays the previous form containing the previously submitted response data. The process then returns to state 132 to wait for additional user input on the currently displayed form. In the response stack in client memory, the pointer is repositioned at the beginning of the responses to the now-current form (i.e., lower in the stack). When the current form is resubmitted, the browser rewrites all responses to the stack. From the user's point of view, however, the previous responses remain unless he or she changes them.

After completing all questions on the current form, the user may request to move to the next form (state 146). The current form's response data are written to the browser stack and sent to the web server at state 148 (FIG. 9C). The web server then determines at state 150 whether more forms are available for this questionnaire. If so, the method returns to state 124 (FIG. 9A), at which the next set of potential forms and associated form linking logic are downloaded from the database. If additional forms are not available, the system presents a “commit” screen (decision state 152) that lists all of the response data collected so far. If the user is satisfied, he or she indicates so, and all current response data are uploaded from the web browser to the database server and stored in the database (state 154). The data uploaded to the database are referred to as committed data, while the data stored at the web browser during completion of the questionnaire are referred to as intermediate data. The questionnaire process terminates at end state 156. If the user does not want to commit the responses, the method returns to state 142 of FIG. 9B.

Many variations to the method can be devised. For example, additional security measures can be implemented as required. If the user accesses the questionnaire over the web, features are added to ensure that the questionnaire can be completed only if both the questionnaire administrator and user are successfully authenticated. In addition, once the user has submitted the response data, he or she cannot modify the data without permission from the questionnaire administrator. In some cases, the questionnaire is completed only at a clinic site, and both a user password and an administrator password are required. The data stored in the database are preferably encrypted or otherwise stored in a manner such that the identity of each patient cannot be determined. In a currently preferred embodiment, responses are saved only at the completion of the entire questionnaire. However, in a further embodiment, the user can save partial responses to the questionnaire and return later to resume completion of the questionnaire. Alternatively, the user can elect to complete only particular forms.

Using the three different condition types is preferred for maximum flexibility and responsiveness. However, depending upon the context in which the questionnaire is used, one, two, or three of the different levels of conditional logic can be employed, and the invention is in no way limited to employing all three types of conditional logic. Furthermore, the different types of conditional logic are described above as being implemented by a specific software module, but any of the different modules may evaluate any of the conditions. Optimal distribution of the evaluations depends upon the memory and processing capabilities of the different computers as well as the transmission bandwidths among the different components of the distributed computer system.

In some cases, it is preferred that the user does not see the question presentation change as he or she enters responses. The user can learn that positive responses increase the length of a form, and therefore decide to enter only negative responses, or, alternatively, decide to trigger as many questions as possible. Rather than present triggered questions as part of the current form, the triggered questions can be contained within a separate form that is presented later in the questionnaire process. In this case, only form linking logic and question assembly logic are employed.

The questionnaire design system 26 (FIG. 1) is a tool by which the clinical researcher or other questionnaire designer creates and edits questionnaires. The purpose of the design system is to allow the designer to change or create the questionnaire forms, questions, and response items without having to edit or create the program code or even understand the underlying program and system. Preferably, the design system has a user-friendly interface. For example, the interface can include separate windows for forms, questions, response lists, and linkages. In the forms window, the designer is presented with a list of existing forms and options to add new forms, edit the names of existing forms, or delete forms. Similarly, in the question window, the designer can add, edit, or delete questions. In the response list window, the designer assembles responses into lists (e.g., a list containing “Yes” and “No”). Finally, in the linkages window, the designer enters the form linking logic, question assembly logic, and question linking logic. To enter the form linking logic, the designer selects a current form and all potential next forms from the list of existing forms. For each potential next form, the designer then selects the questions and responses that trigger presentation of that particular next form. To enter the question assembly logic and question linking logic, the designer selects a form and potential questions and assigns a condition to each question. The design system is useful for allowing a researcher to change the questionnaire content as new information and correlations are discovered.

Questionnaire Content

The present invention has been implemented with a General Clinical questionnaire and a number of disease-specific questionnaires. The General Clinical questionnaire is included in its entirety in Appendix I. In its current embodiment, the General Clinical Questionnaire includes the following forms: General Information; Health Insurance Information; Chief Complaint; General Health; Head and Neck; Thyroid; Eyes; Ear, Nose, and Throat; Pulmonary System; Cardiac System; Abdomen; Musculoskeletal System; Male Genitourinary System; Female Genitourinary System; Lymphatic System; Skin; Emotional Well Being; Nervous System; Social History; Allergies; Current Medication History; Social History; Family History; and Surgical History. Appendix II contains some of the disease-specific questionnaires that have been implemented: Rheumatoid Arthritis; Asthma; Amyotrophic Lateral Sclerosis; Osteoarthritis; Multiple Sclerosis; Parkinson's Disease; Alzheimer's Disease; Anxiety; Depression; and Mania. Of course, questionnaires can be written for any specific condition containing any desired question content and linking logic. Existing medical questionnaires can also be implemented using the questionnaire system of the present invention.

It is instructional to examine some of the General Clinical questionnaire forms to understand the conditional logic of the present invention. Note that the forms and questions presented below are merely illustrative and do not limit in any way the scope of the invention. Many forms contain primary questions that are always presented; positive responses to the primary questions trigger presentation of secondary or screening questions. That is, the question linking logic associated with specific screening questions includes conditional statements evaluating the response to one or more specific primary questions. Positive responses to the screening questions then trigger further hierarchical levels of questions.

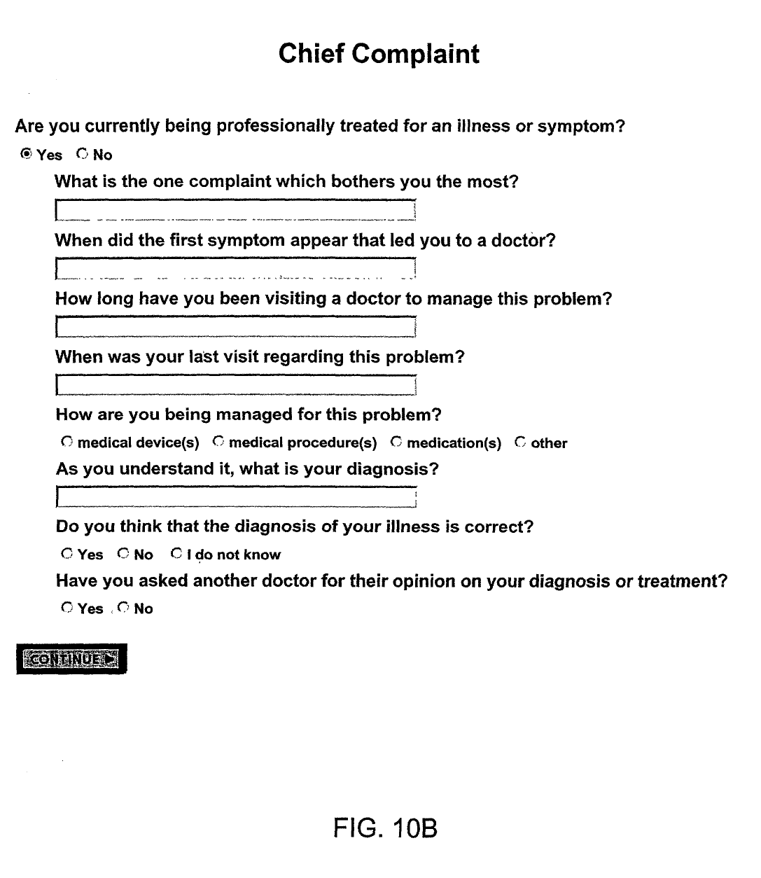

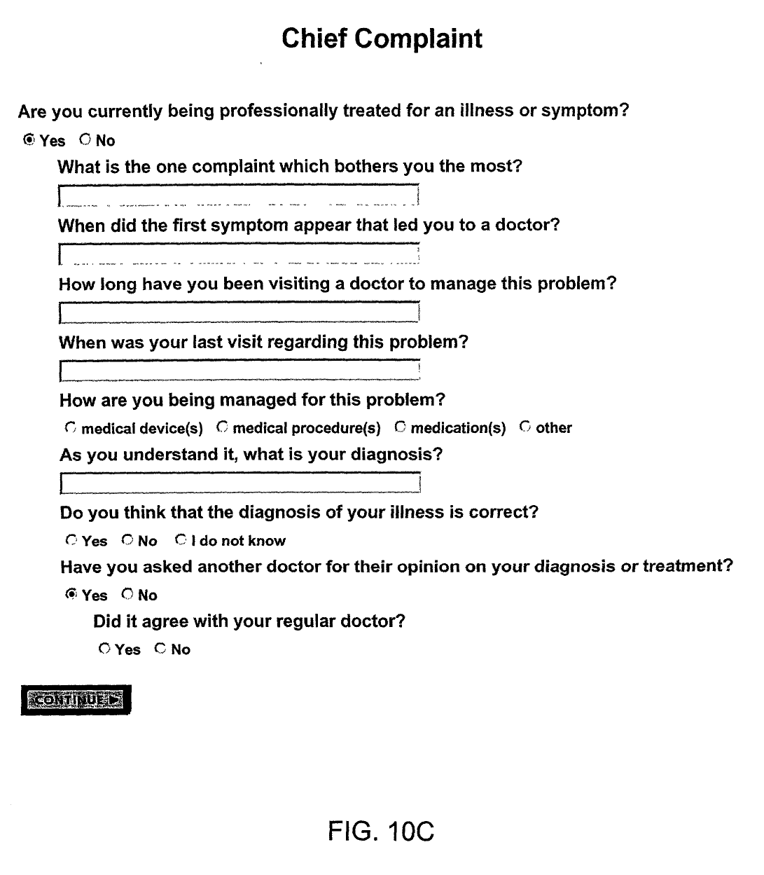

For example, FIG. 10A shows the Chief Complaint form that is initially presented to the subject. It contains a single primary question, “Are you currently being professionally treated for an illness or symptom?” and two mutually exclusive response items. If the subject selects the “No” response, the form does not change. However, if the subject selects the “Yes” response, eight secondary questions are presented, as shown in FIG. 10B. If the subject then selects the “Yes” response to the question, “Have you asked another doctor for their opinion on your diagnosis or treatment?”, an additional question appears (“Did it agree with your regular doctor?”), as shown in FIG. 10C.

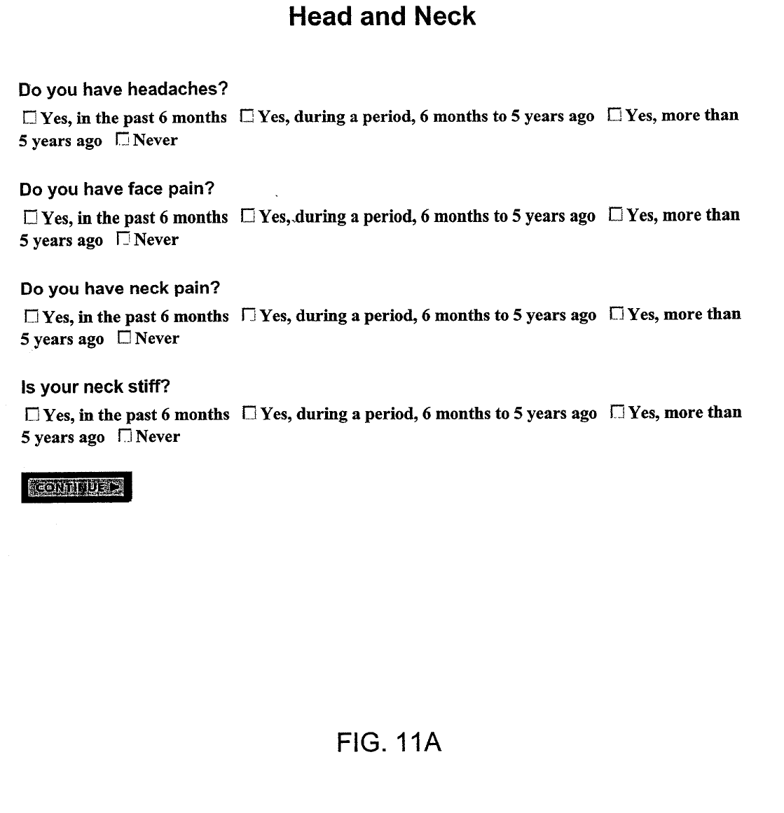

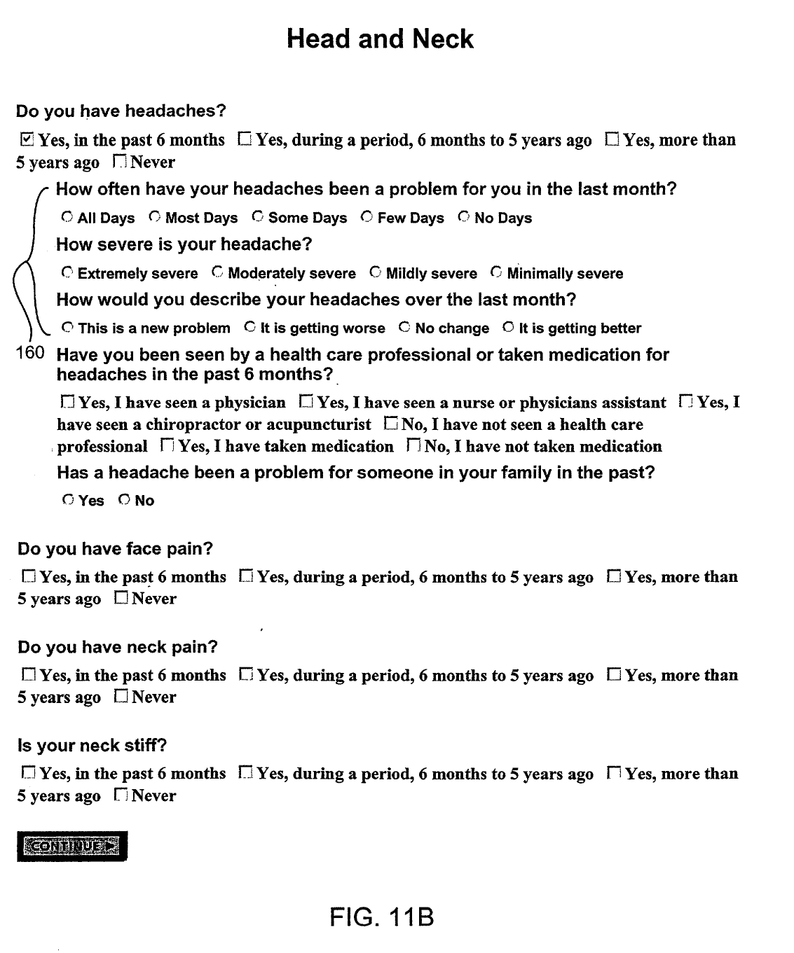

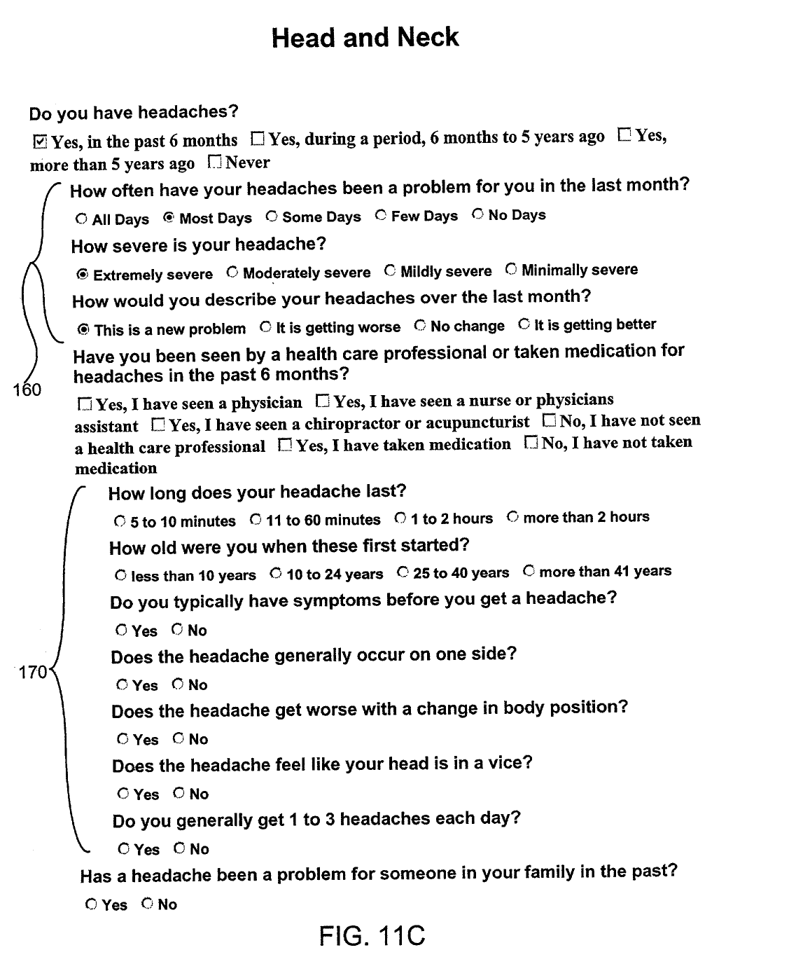

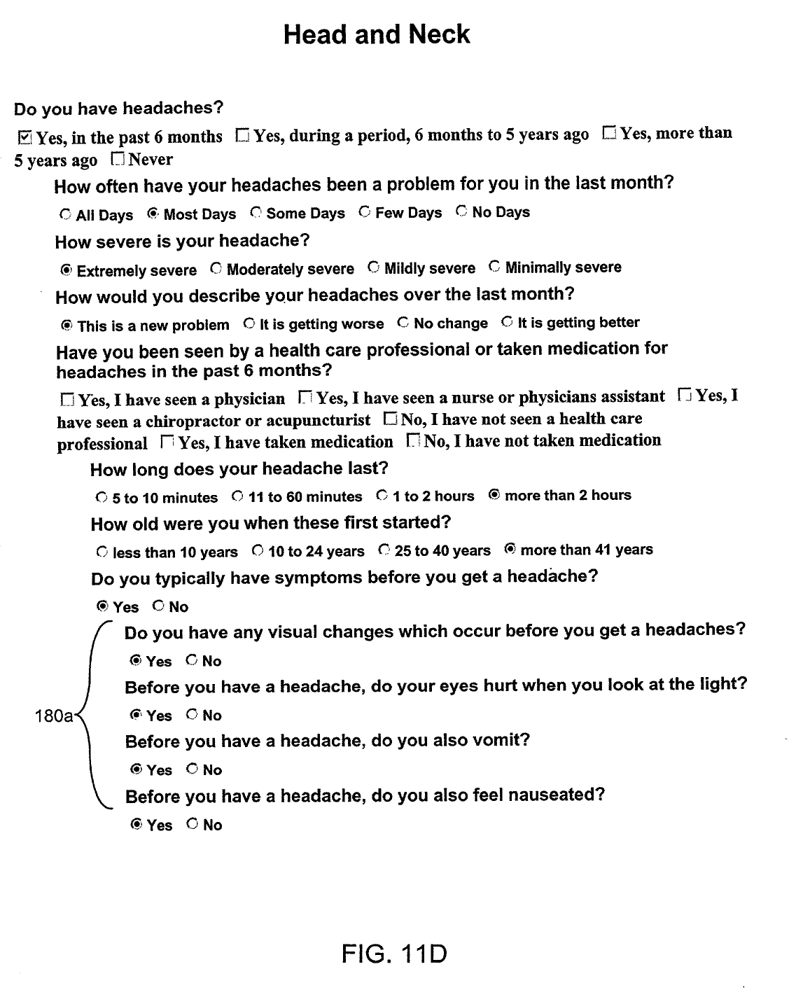

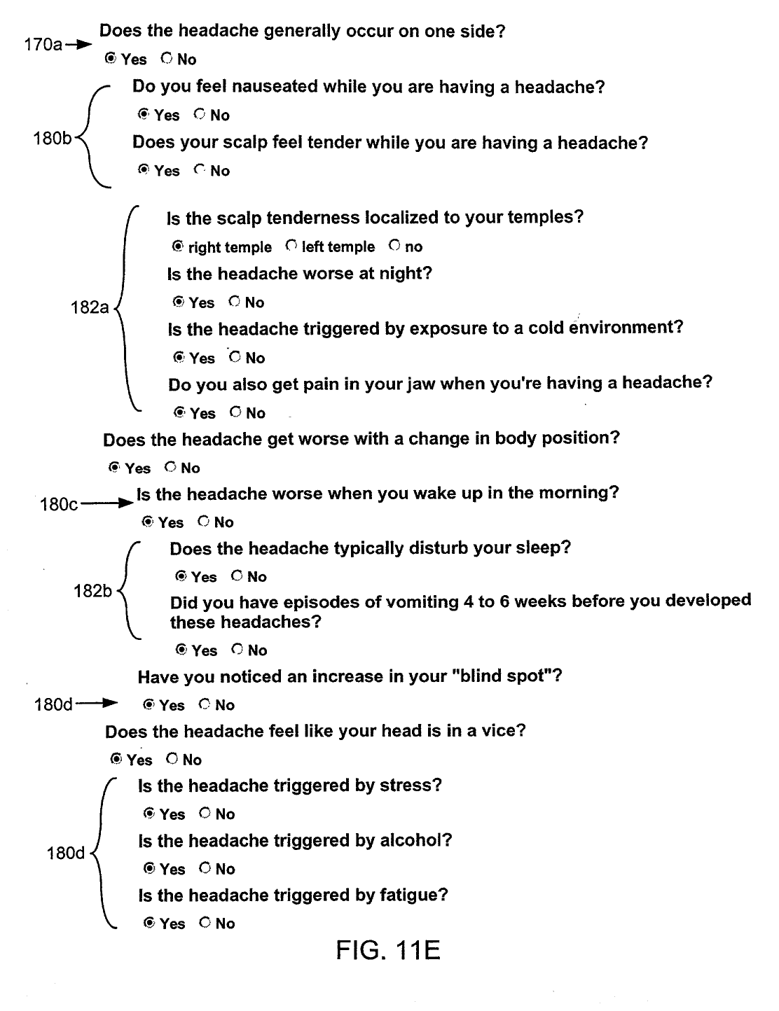

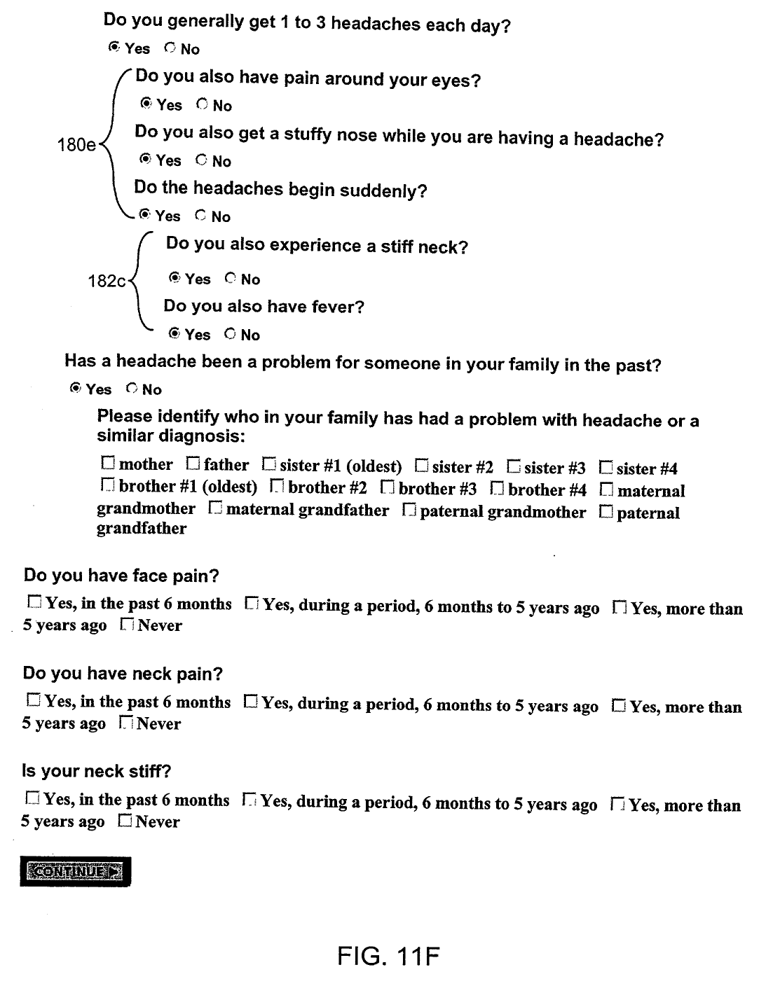

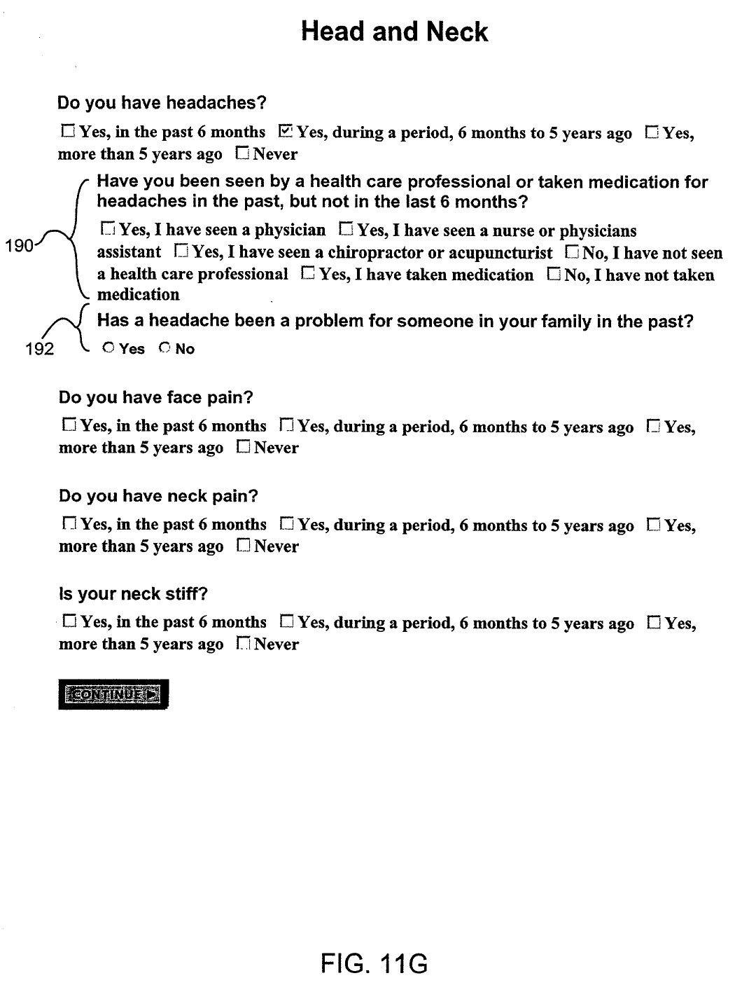

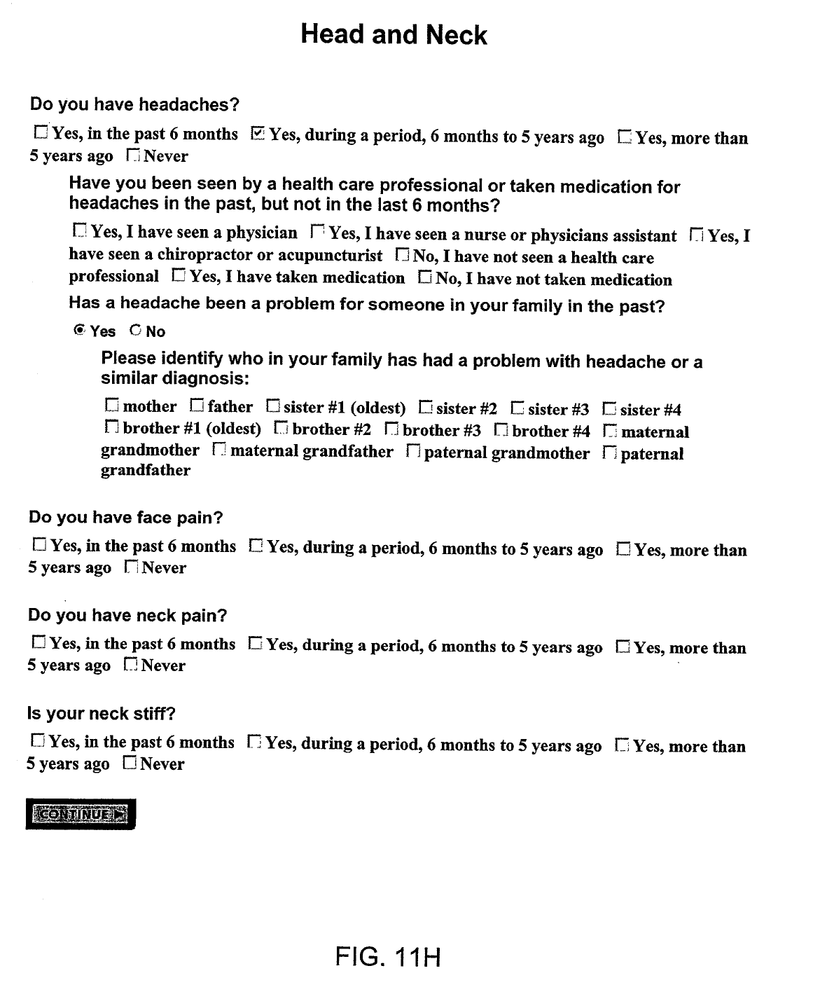

common structure of the forms is illustrated by the Head and Neck form of FIGS. 11A-11F. FIG. 11A shows the form containing four primary questions initially presented to the subject. These primary systemic questions assess the existing condition and medical history of the subject, determining whether the subject experiences particular symptoms and, if so, over what period of time. If the subject selects the response “Yes, in the past 6 months” to the first question, then the three screening questions 160 shown in FIG. 11B appear. These three questions 160 determine the frequency, severity, and level of change of the symptom (headaches, in this case) in the past month. Particular importance is given to recent symptoms in the questionnaire, because an important application of the invention is to identify biological markers corresponding to early stages of a disease.

A particular combination of responses to the three screening questions 160 is considered a positive response and triggers additional or secondary questions 170, as shown in FIG. 11C. In this example, a positive response is a new headache problem in which extremely severe headaches have been a problem on most days in the last month. In fact, in the current implementation, a positive response for headaches is considered to be a frequency of “All Days,” “Most Days,” or “Some Days”; a severity of “Extremely severe,” or “Moderately severe”; and a level of change of “This is a new problem,” “It is getting worse,” or “No change.” The combination of screening question responses considered to be a positive response varies for different symptoms and systems. For example, on the Abdomen form, a response of “Few Days” (i.e., fewer than “Some Days”) to the question “How often has blood in your urine been a problem for you in the last month?”, in combination with extreme or moderate severity and symptoms that are not improving, is considered to be a positive response, while it is not for headaches. Thus, the severity or frequency of a symptom alone does not determine whether a positive response has been received. Medical knowledge is required to determine which responses should trigger further questions. In this case, infrequent blood in urine is (in general) known to be a more significant finding than infrequent headaches.

The format of using branching logic and multiple levels of questions was designed in order to capture as much clinical information as possible. As the levels of questions increase further, the question content becomes more detailed, and there is an accompanying increase in probability that the symptoms experienced by the patient are characteristic of a recognized disease or syndrome. In fact, the questionnaire is preferably designed so that sequentially displayed questions trace a known medical pathway corresponding to a disease, organ system, pathophysiology, or medical condition. As a result, the level of questions triggered can be correlated with potential clinical conditions of a particular patient. As used herein, a medical pathway is a particular path through a tree structure whose nodes represent symptoms. Each leaf node or intermediate node is associated with one specific disease or condition, but many nodes can correspond to the same condition.

This principle is illustrated in FIG. 11C. A positive response to the screening questions 160 is indicative of a disease or symptom that may warrant medical attention or about which further information should be obtained. Questions 170 elicit further information from the subject in order to identify the appropriate disease pathway. Positive answers to the additional questions 170 trigger additional “drill-down” or lower-level questions 180a-180e, as shown in FIGS. 11D-11F. Yet further levels of questions 182a-182c are presented in response to positive responses to questions 180. As shown, each question level can be further indented to indicate its level. Preferably, the subservience relationships among questions (FIG. 7) determines the indenting and also defines the question level. If the subject arrives at one of the low-level or drill-down questions, possible diseases can be identified. For example, if a patient responds positively to the questions 170, 180b, and 182a, “Does the headache generally occur on one side?”, “Do you feel nauseated while you are having a headache?”, “Does your scalp feel tender while you are having a headache?”, “Is the scalp tenderness localized to your temples?”, “Is the headache worse at night?”, “Is the headache triggered by exposure to a cold environment?”, and “Do you also get pain in your jaw when you're having a headache?”, then the subject exhibits many of the symptoms of temporal arteritis, and this disease should be considered as a possible diagnosis. Alternatively, if the subject responds positively to the questions 180a, then migraines should be considered as a possible diagnosis.

Note that the medical pathway structure of the questions, although useful for recommending potential diagnoses, is primarily designed for thorough information-gathering purposes. That is, the structure enables the invention to acquire detailed information about symptoms that are not currently known to be correlated with medical conditions. For example, if a particular type of headache is a currently unrecognized symptom of a certain disease that the patient has or will develop, the correlation can only be made if sufficient details of the headache are obtained. Without such details, the symptoms are typically too broad to be able to identify a correct and meaningful correlation. Note also that the lower-level or drill-down questions 180 and 182 shown in FIGS. 11D-11F are only presented when positive responses are provided to the higher-level questions. As used herein, higher-level questions are those that require fewer positive responses in order to be presented than do lower-level questions. Of course, these terms are relative and do not refer to any particular level number.

FIG. 11G shows the screening questions that appear when the user indicates a symptom appearing more than six months ago. In this case, question 190, “Have you been seen by a health care professional or taken medication for headaches in the past, but not in the last 6 months?” elicits more detailed medical history information. A similar question, but directed to the past six months, is presented if the user indicates a symptom appearing in the past six months. If the subject responds that he or she has seen a physician, nurse, physician's assistant, chiropractor, or acupuncturist, an additional question, “Did you undergo a medical procedure or an operation for headaches in the past, but not in the last 6 months?”, is presented. This information is important in determining whether the patient's responses have been biased by the medical treatment. For example, a patient's symptoms may have been alleviated as a result of effective treatment. In addition, the fact that a person's symptoms were significant enough to merit a visit to a health care provider and receive medication highlights the degree of severity of the symptom, which can be incorporated into the evaluation logic.

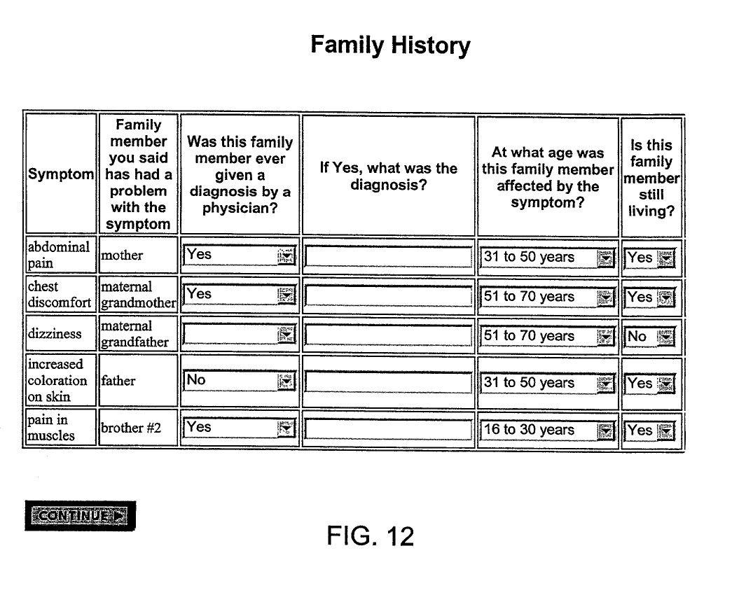

Question 192, “Has a headache been a problem for someone in your family in the past?”, is triggered by any response (including “Never”) to the primary question. Family history questions gauge a genetic disposition to a particular disease and are useful for identifying pre-symptomatic markers of a disease. They are displayed even if the symptom is not currently relevant to the individual taking the questionnaire. If the subject responds positively, an additional question appears to determine which family member had the same symptom, as shown in FIG. 11H. After the subject completes the screening forms, a Family History form, shown in FIG. 12, appears, in which the subject can enter more details about the symptoms that he or she indicated previously. The Family History form is assembled using question assembly logic that evaluates the answers to all previous family history questions. In the Family History form, the subject can enter additional information about the family member's diagnosis, age at which the symptom first appeared, whether the family member is alive, and (if deceased) whether he or she died from the indicated problem.

Similar forms are provided near the end of the general questionnaire to collect details on the subject's Current Medication History and Surgical History. These forms are assembled using question assembly logic that evaluates response data to all of the medication questions and medical procedure questions, respectively, on the previous screening forms. In some embodiments, the database server can be in communication with an external medical records application whose data can be transferred to the database used by the present invention. For example, data from a commercially available medication history electronic records application can be transferred directly into the table represented by the Current Medication History form. In this case, it is required that the data format used for storing collected clinical information is compatible with the data format of the external application.

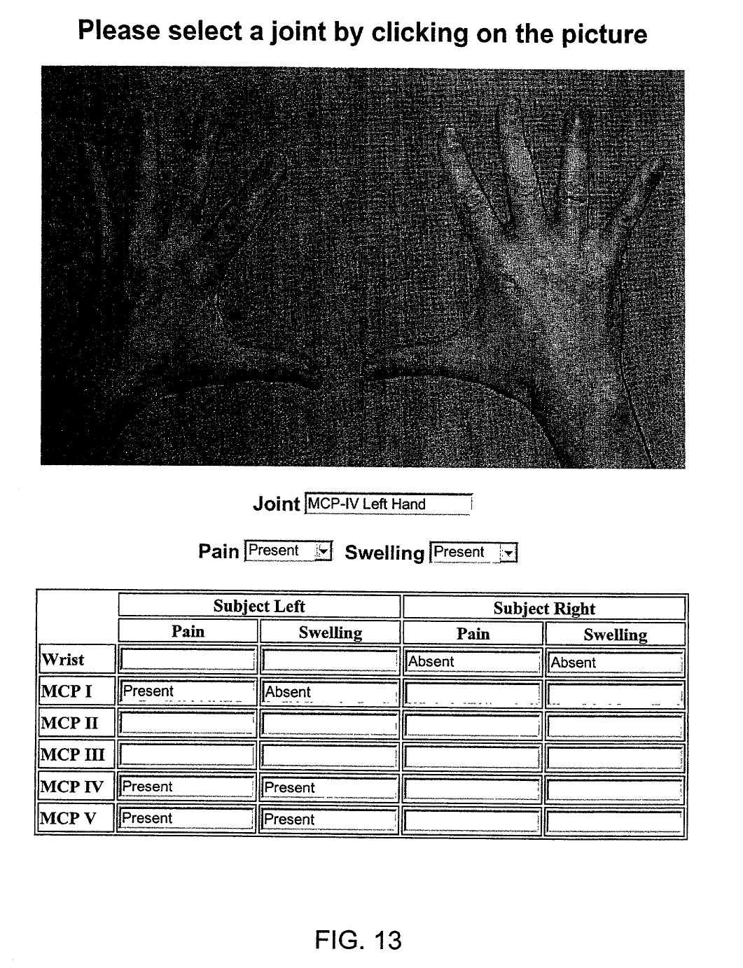

Questions and responses are not necessarily presented in text format only. For example, a simple, intuitive method is to present a graphical display of the body and invite the subject to select (e.g., with a mouse pointer) an area of the body exhibiting symptoms. FIG. 13 illustrates a display depicting a pair of human hands. The subject can select a specific hand joint and then indicate the presence or absence of pain and swelling at that joint with a mouse click. In another example, the questionnaire system can be in communication with a commercial medication software package that provides images of different medications, useful to help patients identify medications whose name and dosage they do not remember. The images can organized by symptom and displayed to the patient on the relevant form. The patient can then select the picture corresponding to the appropriate medication. The questionnaire can also optionally be displayed in a select number of foreign languages. One way to do this is to store all questions and responses in multiple languages and have the user select the desired language upon beginning the questionnaire. Questions can also be presented in audio format. For example, questions can be read to visually impaired patients, and answers received via voice recognition software that converts spoken responses into a data format for transfer and storage in the database. Any desired formats or combination of formats for eliciting information can be used.

Furthermore, questions can be open-ended, allowing the subject to enter free text, or they can offer a set of predetermined response items. Note that although the questionnaire of the present invention is referred to as consisting of questions, it is to be understood that the word “question,” as used herein, refers to any element of the questionnaire to which a subject can respond by submitting subject data. For example, the phrase “on the picture, please indicate which joints are painful for you” is equivalent to a question.

As discussed above, the interface between the patient and the questionnaire can also be adapted to receive physical data. Thus, for example, a patient complaining of weakness can be asked to squeeze a deformable handle; the results, recorded electronically, become part of the data transmitted to the database server.

In an alternative embodiment, the evaluation conditions are based not only on responses to questions, but on other relevant patient information stored in the database or in a different database in communication with the web server. For example, results of laboratory tests performed on the subject's blood sample can be stored. Conditions can then include, e.g., ranges of measurement values detected during the tests.

An additional feature of the invention is a consistency test of the user's responses. Particularly if the user has entered positive responses to a number of screening questions, the same or similar questions are presented on different forms, and the responses are compared to verify their consistency. For example, common symptoms of congestive heart failure include difficulty breathing, chest tightness, and swelling of the feet. Thus on the Cardiac System form, if the subject reports severe and frequent difficulty breathing, questions about feet swelling and chest tightness are presented. Similarly, if a subject reports shortness of breath when at rest or with minimal activity on the Pulmonary System form, questions about feet swelling and chest tightness are presented. Responses to the questions on the two forms are compared for consistency. If significant inconsistencies are found, the subject is alerted and asked to verify the correct response. Commonly-occurring inconsistencies indicate that the questions do not convey their intended meaning. Such inconsistencies are monitored and used to improve the question clarity. Also, questions can be included to screen subjects who are potentially not providing truthful responses. Occasionally, subjects answer questions based on what they think the “correct” answers are, or exaggerate their symptoms to present a more pathological health profile. Answers to particular questions or statistical analysis of a set of questions reveals the inaccuracy of these subjects' responses. In addition, because many questions are subjective in nature, responses may not represent an accurate and uniform measurement of the symptom. For example, different people have different pain thresholds and may report the same physiological level of pain differently. To account for such differences, questions can be added to gauge a subject's assessment of different degrees of pain, and response data can be weighted in dependence on a particular subject's pain threshold.

In a preferred embodiment, question responses are weighted in dependence on the severity of the symptom indicated by the response. The type of weighting used depends on the additional application that will be processing the collected data. For example, the weighting can be incorporated into the conditional logic, so that a question is presented if the weighted sum of previous responses exceeds a set value. Alternatively, the weighting can be used to determine whether the combination of responses is indicative of a disease and warrants further attention. If the total score is higher than a predetermined amount, the system is triggered to perform an additional operation, such as displaying additional forms, issuing clinical warnings, or suggesting referral of the patient to a specialist. Alternatively, the weighting can be stored in the database and used for subsequent data mining applications that search for biological markers.

In a simple embodiment, the weighting system is determined by the question level. For example, positive responses to questions 182 of FIG. 11D-11F, fifth-level questions, receive a higher weight than positive responses to questions 180, fourth-level questions. This weighting system reflects the design of the questionnaire, in which deeper-level questions concern specific disease symptoms. Alternatively, weights can be assigned differently to different positive responses to a single question. Thus, for a question that asks, “How many asthma attacks have you experienced in the last three months?” a response of “Four attacks” may be accorded a higher weight than “Three attacks,” although both are considered positive responses. As a further feature, the evaluating logic can assign various weights to combinations of responses.

Preferably, the weighting is not arbitrary, but rather reflects existing medical wisdom. Moreover, the evaluating logic is preferably designed so that it can be modified or revised to reflect new medical knowledge or feedback from clinicians using the questionnaire system. For example, clinicians using the questionnaire may learn through experience that a certain response is being weighted too heavily and is actually not as meaningful as originally believed. This type of feedback concerning weighting can be provided by a clinician, or the evaluation logic can make this determination itself by analyzing the sensitivity, specificity, or error rate of the questionnaire or the feedback from the clinicians. If the evaluation logic determines that the weight accorded a response is inappropriate, it can register an alert or even adjust the weight automatically. In this way, feedback from clinicians and internal evaluations can be used both to validate and to monitor the performance of the questionnaire. More generally, physicians can evaluate the question content and organization to ensure that relevant questions are being asked and that the questions are eliciting the intended response. As the content of the questionnaire system is updated, appropriate version control methods are applied so that it is always known which questions correspond to the stored response data.

It is anticipated that the questionnaire will be used to collect longitudinal patient data, i.e., data from the same patient at regular or irregular time intervals. All time-varying data are preferably stored in the database. Data collected at a later time are referred to as later-time data. Preferably, when a subject completes the questionnaire for the second and subsequent times, the questionnaire appears with previous data entered. The user can then selectively change data reflecting modified symptoms without having to complete the entire questionnaire. In some cases, questions whose responses do not change (e.g., gender, for most subjects) are not presented at subsequent sessions.

Although the questions are described as being stored as strings, symptoms can also be represented using more semantically structured data types. Preferably, the data types do not use a full natural language representation, but rather use a representation whose complexity is intermediate between a natural language representation and a string. For example, systems exist to classify symptoms into codes. ICD9 codes are diagnosis codes used by insurance companies to track diagnoses and verify requested procedures. SNOMED (Systematized Nomenclature of Medicine) is a nomenclature standard for symptoms and diagnoses that uses a hierarchical structure. SNOMED allows for integration of data from many sources. In the present invention, structured data types facilitate subsequent data mining. In addition, structured data types enable automatic translation of the questions and responses. Standard question templates are provided for desired languages, and the semantic context of a question element (translated into multiple languages) determines which template to use and how to incorporate the element into the template.

Data Analysis

Data collected by the dynamically unfolding questionnaire of the present invention can be analyzed using a wide variety of techniques, depending upon the intended purpose and application. Analytical tools are divided into two main categories: patient-oriented and research-oriented. Patient-oriented analysis focuses on clinical data collected from a given patient, while research-oriented analysis mines clinical and laboratory data collected from a large population of patients to find novel correlation patterns among the data.

Because the questionnaire design reflects the medical knowledge with which it is created, the path taken by a patient through the questions provides information about the patient's condition and medical history. Deeper-level questions, if presented, are associated with higher probabilities of particular diseases. In a relatively simple embodiment of patient-oriented analysis, the number of questions that are triggered at each level by the question presentation logic is counted for each form, organ system, or symptom type. If a form's primary questions only are presented, then the patient has no relevant symptoms. If secondary questions are presented, however, the symptoms may warrant further attention. In general, the more questions presented for a particular system or form, the higher the likelihood that the symptoms should be reported to a physician.

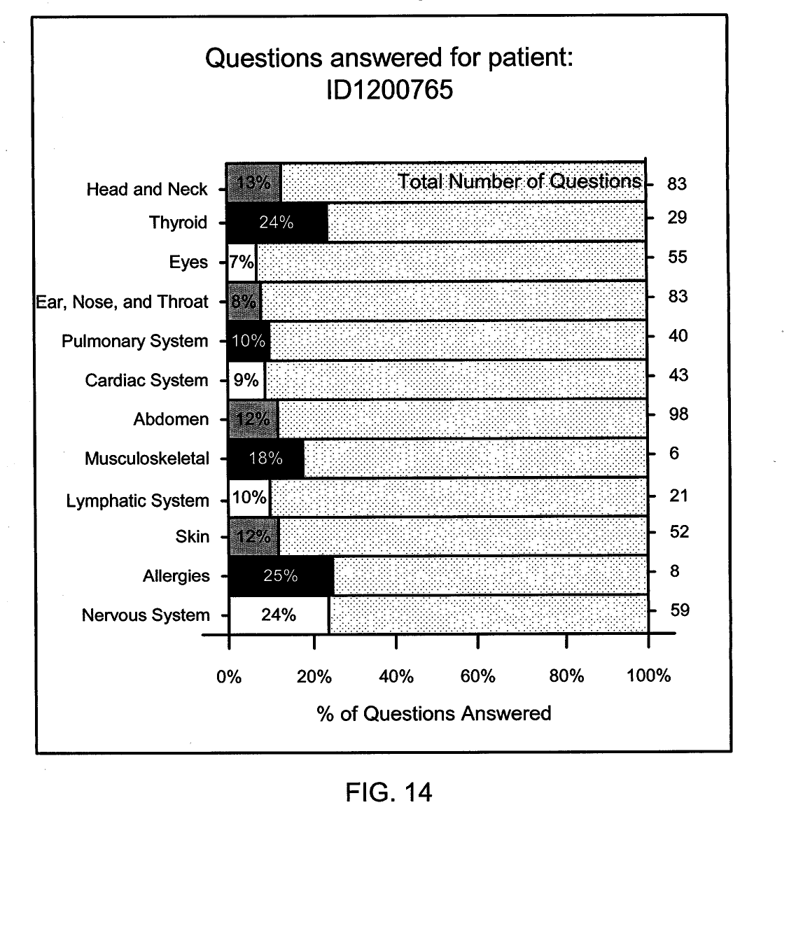

A summary analysis of a subject's response data can be presented in tabular, graphical, or any other desired format. In general, a summary refers to any presentation of the response data, with varying degrees of analysis performed on the data before presentation. FIG. 14 shows an exemplary graphical summary form of the invention. For each form presented, the summary presents (in this case, as a bar graph) the number of questions answered by the subject and the total number of questions. Alternatively, the summary can identify the level of each question answered. For example, the presented questions in the Nervous System form, 24% of the total questions, can be further differentiated into primary, secondary, tertiary, or deeper-level questions. The summary can also provide information (for example, in a third dimension graphically) summarizing the responses of the patient over time.

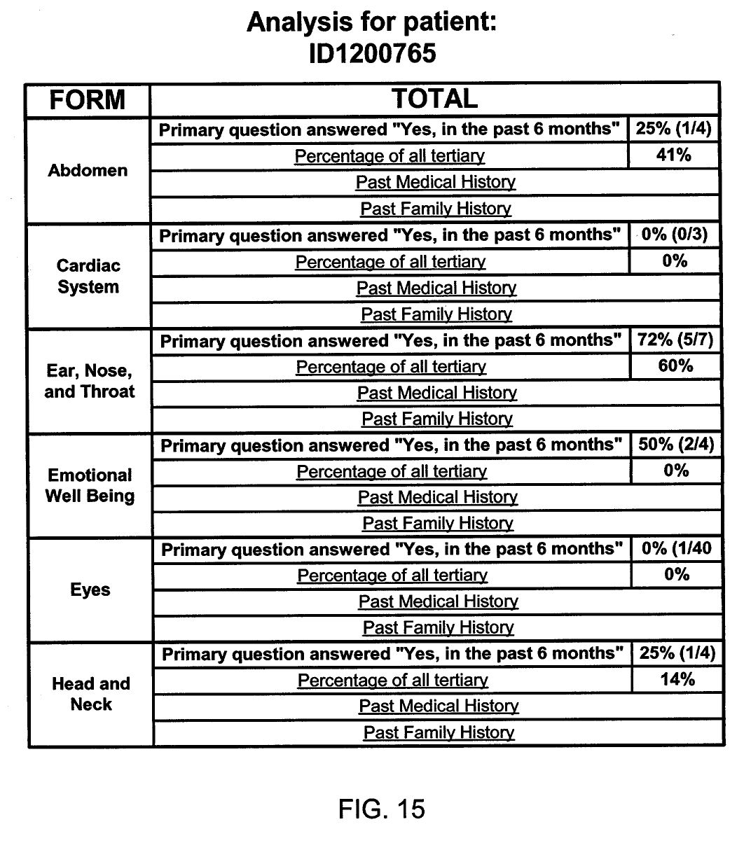

As with all patient-oriented analysis, the summary can be directed toward the patient or a treating physician (e.g., depending on an access code entered). For example, the patient can use the summary to help determine whether he or she should seek medical attention. Alternatively, the summary analysis can be usefull as an overview for a treating physician in evaluating a patient's questionnaire responses. FIG. 15 shows a tabular summary form. Specific regions of the summary are hyperlinked to portions of the questionnaire so that the physician can review the relevant portions of the questionnaire to facilitate more efficient examination of the patient. For example, the physician can select “Past Medical History” to view a list of the relevant questions to which the user responded positively.

A more complex analysis takes advantage of the medical pathway information inherent in the question presentation logic. Because the sequentially deeper levels of questions are designed to narrow in on specific positive signs or symptoms, answers to specific questions often can be correlated with specific conditions. In the present invention, a medical pathway is a Boolean expression of atomic expressions of the form Qᵢ=Rᵢⱼ, where Qᵢ is a question identifier and Rᵢⱼ is the j^{th} response item of the i^{th} question. Medical pathways are represented in conjunctive normal form (CNF): Λᵢ(Vⱼ Qᵢ=Rᵢⱼ)→Dₖ. Each disjunction denotes a choice of one or more responses to a question in a path, and the conjunction denotes the path to generate a medical condition Dₖ. Note that more than one path can lead to a given condition. Medical pathways are preferably stored in the database in two tables, a first table storing triplets [question, response item, conjunction identifier], and a second table expressing the conjunction of triplets and mapping to the medical condition. However, the optimal data structures used depend on the specific database, and any suitable data structures can be employed. As with the question and form linking logic, storing the medical pathways in a database offers more flexibility in access and maintenance than if they were encoded in a software program. A pathway design system similar to the questionnaire design system is preferably provided so that a questionnaire designer can create and edit the medical pathways without having to access the program code.

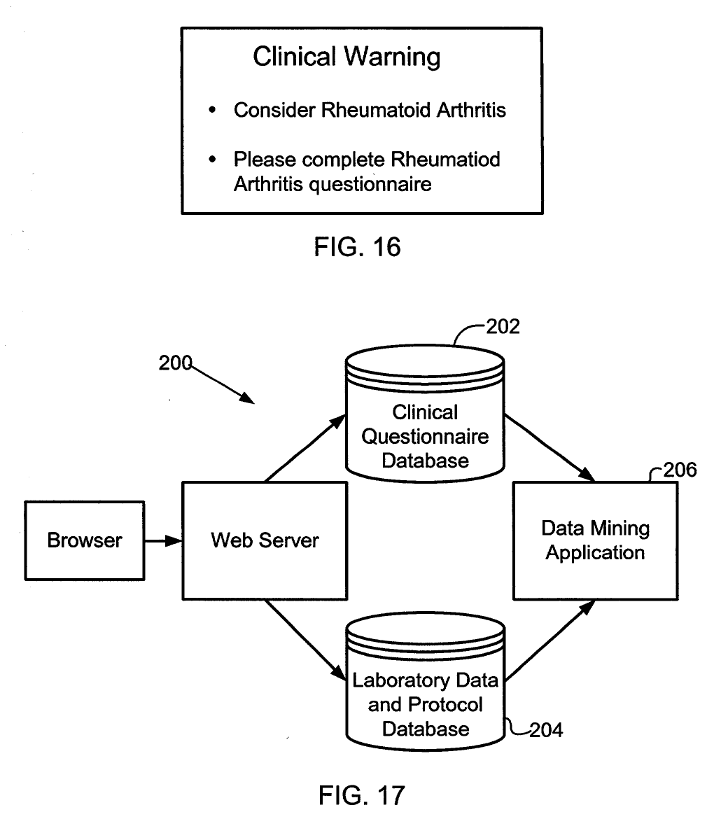

Medical pathways can trigger clinical warnings to the patient or physician, either during or after the exam. A patient's clinical warning typically directs a patient to contact a physician (e.g., “Consider seeing a neurologist”), while a physician's warning suggests possible diagnoses (e.g., “Consider ruling out multiple sclerosis”). When a patient completes a form and submits it to the web server, the web server compares the results with clinical alert conditions representing the medical pathways that were downloaded from the database. In one embodiment, the browser displays a clinical warning screen, illustrated in FIG. 16. In this case, the subject is requested to complete a clinical questionnaire specific to the disease associated with the identified medical pathway. Note that the medical pathways are not limited to questions on a single form. For example, a medical pathway leading to multiple sclerosis contains positive responses to the questions “Do you have blurry vision?”, “Do you have muscle weakness?”, and “Do you have numbness in any of your limbs?”, located on the Eyes, Musculoskeletal, and Nervous System forms, respectively.

Alternatively, only the physician, questionnaire administrator, or other designated person has access to the clinical warnings. Rather than display a warning, the web server links to an application that alerts the subject's identified physician or other designated person via, for example, email, telephone, or pager. Alternatively, the clinical alert can be written to a database or file that the physician accesses after the subject completes the questionnaire. For example, the physician can access a secure web page to view the clinical warnings, the questions in the pathway triggering this warning, the potential responses, and the subject's responses.

The medical pathway analysis can be extended by including weighting of the responses, as explained above. While the above representation assigns a common value to all responses (either true or false), question and response pairs can be weighted to allow a more precise evaluation of symptoms. Rather than either triggering or not triggering a warning, the questions and responses in a particular medical pathway can be scored to determine the severity of the symptoms. The warnings are then graded to correspond to the score. For example, if the symptoms are severe, the patient is advised to seek medical attention immediately, but if the symptoms are not severe, the patient is simply informed of the condition.

Additionally, the clinical pathways can include a temporal component, particularly if the questionnaire is used to collect longitudinal data. For example, a rapid increase in symptom severity may correspond to a medical condition, while a decrease in symptom severity over time will not trigger a warning. Time-sensitive rules are expressed as [Λᵢ(Vⱼ·Qᵢ(t)=Rᵢⱼ)] Λ[Λtσt′]→Cₖ, where Rᵢⱼ is the response at time t and σ is a temporal operator.

When only patient-oriented analysis is performed, the questionnaire system of the invention, including summary and medical pathway analysis tools, can serve as a stand-alone information gathering tool. This is particularly important as patients become more responsible for their own health care and have more access to medical information on the Internet. As informed consumers of health care, patients benefit from obtaining accurate symptomatic information, in order both to direct a medical information search and to determine whether a physician or specialist is needed. In fact, there are presently several companies whose employees receive a lump sum of money for use in managing their own health care expenses. These employees therefore have an incentive to use their health care resources efficiently. In one patient-centered implementation of the invention, a patient accesses the questionnaire over the web and receives summary and clinical warning feedback (e.g., “consider making an appointment to see your primary care physician to discuss these symptoms”). The patient can then determine whether or not to seek medical attention. Alternatively, the clinical warnings can suggest an electronic consultation with a physician (e.g., “consider sending an email to your physician to discuss these symptoms.”). There is a growing trend to have patients email their physicians with medical questions, for which the physician is reimbursed by health insurance plans. The questionnaire system of the present invention can help optimize the electronic patient-physician interaction and therefore facilitate efficient use of health care resources. In the patient-oriented embodiment, each time the patient completes the questionnaire, the data are stored for comparison with past and future data. Preferably, the patient need only complete the questions whose responses have changed since the previous questionnaire administration.

Alternatively, after questionnaires of the present invention have been sufficiently validated, insurance companies can rely on the questionnaire results to verify which services are appropriate for the patient, thereby minimizing the cost for unnecessary services. In this case, the patient completes the survey before a physician visit but does not access the analysis results. Instead, the response data are transmitted to the physician to become part of the patient's medical records. For example, the patient can complete the questionnaire over the web and store the resulting data on a portable device such as a magnetic stripe card or floppy disk. The portable device can then be read by the physician's office. Alternatively, the patient can transmit the data over the Internet using a secured connection. The physician then reviews the response data or summary information prior to the patient visit. In this implementation, the physician (or the nurse practitioner, physician's assistant, etc.) can more efficiently use the time that would otherwise be spent obtaining the patient history, thereby decreasing the cost of the visit. In a further implementation, the questionnaire can be available to subjects at the recommendation of their physician, and the collected data used to identify subjects eligible for a particular clinical trial.

Another important application of the questionnaire system of the invention is as part of an integrated data mining platform for biological marker (biomarker) discovery. When the invention is used to obtain comprehensive clinical symptoms from a large number of patients over multiple time points, the data can be analyzed to discover novel biomarkers. Particularly relevant are symptoms reflecting the early stages of a disease, i.e., symptoms that have appeared recently. Biomarkers can be of many types, including, but not limited to, diagnostic, indicating whether a person has a particular condition; therapeutic, indicating the efficacy of a particular treatment; prognostic, indicating the expected progression of a disease; and stratifying, useful for separating subjects in a clinical study into groups. For example, the early stages of a disease may be manifested by a specific symptom or set of symptoms that have not yet been recognized, perhaps because they are ordinarily not of sufficient strength or duration to be brought to the attention of a physician, or perhaps because the symptoms are not conventionally associated with the disease. When the present invention is used to collect data over a long time period, the early symptoms can be discovered by analyzing earlier data from subjects who develop a condition during the data collection period. In addition, complex patterns of symptoms, which are particularly difficult to extract when a subject has multiple diseases, can be discovered. Biomarker knowledge can be used for a wide variety of applications such as evaluating therapeutic treatments, monitoring disease progression, and developing new drugs.

Preferably, other biological and medical data are collected and analyzed with the clinical data. For example, a comprehensive bioanalysis of patient blood samples can identify a biomarker (e.g., increase in a specific cytokine as a marker for development of rheumatoid arthritis), which can then be correlated with a clinical symptom obtained by the present invention. Note that a biomarker is not limited to the presence of a certain symptom; it includes without limitation a pattern of symptoms, a symptom in combination with a positive laboratory value, and so on.

The present invention is particularly well suited for biomarker discovery because it facilitates the collection and analysis of a large amount of clinical data about a wide variety of organ systems, patient behaviors, and family medical histories. Locating novel patterns requires that the collected data not be limited to data relevant to potential patient diagnoses, but rather include data that are neither known nor predicted to be correlated with existing conditions. The more varied the type of data available for mining, the more likely that biomarkers can be discovered. Furthermore, the statistical methods by which biomarkers are discovered benefit from data collected from a large number of subjects.

A block diagram of a system 200 for biological marker discovery is shown in FIG. 17. A first database 202 stores questions, forms, conditions, and patient responses of the questionnaire system. A second database 204 stores additional data such as laboratory test data for an entire patient population. Laboratory data refer to the results of laboratory tests performed on biological fluids (e.g., blood) obtained from patients, such as immunoassays or cellular assays. While shown as distinct databases, the databases 202 and 204 can instead be a single physical database. A data mining application 206 is in communication with the questionnaire database 202 and the laboratory database 204 to mine both databases for novel correlations and patterns among the different data types. The databases 202 and 204 are preferably structured to facilitate data mining by the application 206.

Data mining is characterized by repeating cycles of training and testing. First, in order to find possible correlations, trends or patterns, data are analyzed using the data mining tools. In the learning phase, relevant variables are identified and preliminary rules or hypotheses are developed concerning relationships among the variables. These presumptive rules are then tested by applying the rules to new data and evaluating how well they predict or describe that new data. Discrepancies among predicted and actual results are used to revise or reject the rule.

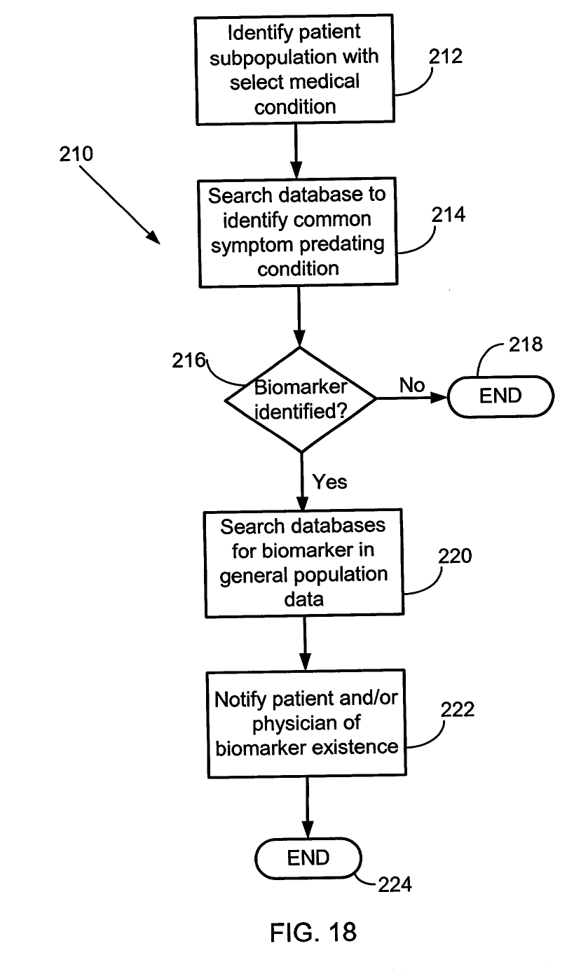

FIG. 18 is a flow diagram of a simplified potential biomarker discovery method 210 facilitated by the present invention. At state 212, a sub-population of patients whose response data have been collected and who have a well-defined medical condition, such as asthma, are identified. At state 214, the database is searched to identify common physical symptoms or laboratory values (collectively, phenotype data) that appear to be correlated with the medical condition. For example, it may be found that an elevated level of Factor A in the blood combined with Symptom B indicate the early stages of disease Condition C.

At decision state 216, it is determined whether biomarkers are identified. If not, the process terminates at end state 218. However, if one or more biomarkers are identified, the questionnaire responses and laboratory data of the general population are searched to detect the presence of the identified biomarkers at state 220. At state 222, the patient and/or the patient's physician are notified of the existence of the biomarker and its relation to the particular medical condition. This information will enable implementation of early treatment of disease with the goal of reduced morbidity and mortality. The process terminates at end state 224.

It is to be understood that the various method steps described above are highly simplified versions of the actual processing performed by the client and server machines, and that methods containing additional steps or rearrangement of the steps described are within the scope of the present invention. Furthermore, although the questionnaire system has been described in the context of obtaining human health data, the principles of the invention can be applied to any analogous system in which a broad set of data is acquired for analysis to discover new associations among the data, for example, tracking the health of laboratory animals or studying automobile maintenance and driver behavior.

It will be apparent to one skilled in the art that the above embodiments may be altered in many ways without departing from the scope of the invention. Accordingly, the scope of the invention should be determined by the following claims and their equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A computer-implemented method for obtaining clinical data, comprising:
obtaining a plurality of medical questions and at least one question linking condition from a database;
presenting at least one of said medical questions to a user;
receiving response data from said user; and
in dependence on said response data and said question linking condition, determining which additional of said medical questions to present to said user.

2. The method of claim 1, wherein each of said medical questions is associated with a corresponding question linking condition, and wherein said determining step comprises evaluating each of said corresponding question linking conditions in dependence on said response data.

3. The method of claim 2, further comprising presenting to said user medical questions whose corresponding question linking conditions evaluate to true.

4. The method of claim 1, wherein said medical questions comprise higher-level questions and lower-level questions.

5. The method of claim 4, wherein said presented questions are higher-level questions, and said method further comprises presenting at least one of said lower-level questions to said user if said response data represent at least one positive response.

6. The method of claim 4, wherein conjunctions of higher-level question responses and lower-level question responses represent medical pathways associated with predetermined medical conditions.

7. The method of claim 1, wherein said method is performed in a distributed computer system, said database is stored in a server computer, said response data are received at a client computer, and said method further comprises transmitting said medical questions from said server computer to said client computer.

8. The method of claim 7, wherein said determining step is performed by said client computer.

9. The method of claim 7, wherein said determining step is performed by said server computer, and wherein said method further comprises transmitting said response data from said client computer to said server computer.

10. The method of claim 1, further comprising storing said response data in a clinical database.

11. The method of claim 10, further comprising storing clinical data from additional users in said clinical database.

12. The method of claim 10, further comprising, at a later time, repeating said obtaining, presenting, receiving, and determining steps to obtain later-time response data, and storing said later-time response data in said clinical database.

13. The method of claim 10, further comprising storing laboratory data in said clinical database.

14. The method of claim 1, further comprising obtaining clinical alert conditions from said database, and comparing said response data with said clinical alert conditions.

15. The method of claim 14, further comprising presenting a clinical alert to said user in dependence on said comparison.

16. The method of claim 14, further comprising presenting a clinical alert to a designated person in dependence on said comparison.

17. The method of claim 14, further comprising contacting a designated person in dependence on said comparison.

18. The method of claim 14, further comprising presenting disease-specific questions to said user in dependence on said comparison.

19. The method of claim 1, further comprising assigning a weight to said response data, wherein said determining step is performed in further dependence on said weight.

20. The method of claim 1, wherein said presenting step comprises presenting information selected from the group consisting of graphical, textual, and audio information to said user.

21. The method of claim 1, wherein said response data are received via a medical instrument.

22. The method of claim 1, further comprising evaluating the consistency of said response data.

23. The method of claim 1, further comprising presenting a summary of said response data.

24. A computer-implemented method for obtaining clinical data, comprising:
obtaining a plurality of forms and at least one form linking condition from a database, each form comprising at least one medical question;
presenting one of said forms to a user;
receiving response data from said user; and
in dependence on said response data and said form linking condition, determining a second form to present to said user.

25. A computer-implemented method for obtaining clinical data, comprising:
obtaining a first form comprising at least one medical question from a database; presenting said first form to a user;
receiving response data from said user;
obtaining a second form comprising a plurality of potential medical questions and at least one question assembly condition from said database; and
in dependence on said response data and said question assembly condition, selecting included questions from among said plurality of potential medical questions for inclusion in said second form.

26. The method of claim 25, further comprising obtaining at least one form linking condition from said database, and selecting said second form in dependence on said response data and said form linking condition.

27. The method of claim 25, further comprising:
presenting at least one of said included questions to said user; and
receiving second response data from said user.

28. The method of claim 27, further comprising:
obtaining at least one question linking condition from said database; and
in dependence on said second response data and said question linking condition, determining additional of said included questions to present to said user.

29. A program storage device accessible by a processor, tangibly embodying a program of instructions executable by said processor to perform method steps for obtaining clinical data, said method steps comprising:
obtaining a plurality of medical questions and at least one question linking condition from a database;
presenting at least one of said medical questions to a user;
receiving response data from said user; and
in dependence on said response data and said question linking condition, determining which additional of said medical questions to present to said user.

30. A clinical questionnaire system comprising:
a database for storing a plurality of questionnaire objects comprising clinical questions and question presentation conditions;
a web server in communication with said database; and
a web browser in communication with said web server, said web browser for presenting selected ones of said clinical questions to a user and receiving response data, wherein said selected clinical questions are selected in dependence on said question presentation conditions and on said response data.
